(19) United States
(12) Patent Application Publication
(10) Pub. No.: US 2007/0231723 A1
(43) Pub. Date: Oct. 4, 2007

(54) Image forming apparatus, image forming method and toner

(75) Inventors: Masatoshi Kimura, Kanagawa (JP); Hideki Kashimura, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/603,842

(22) Filed: Nov. 24, 2006

(30) Foreign Application Priority Data
Mar. 28, 2006 (JP) 2006-087914

(51) Int. Cl. G03G 15/06; G03G 9/093

(52) U.S. Cl. 430/108.1; 399/222; 430/100; 430/110.1; 430/110.2; 430/108.23

(57) ABSTRACT

An image forming apparatus includes: an image carrying member, a toner feeding unit that forms a charged toner on a surface of the image carrying member, a toner image forming unit that forms a reversely charged toner image by applying charge to the charged toner according to image information, the applied charge having a polarity contrary to the charged toner, a color forming information applying unit that applies color forming information to the reversely charged toner image with light, a transferring unit that transfers the reversely charged toner image to a surface of a recording medium, a fixing unit that fixes the reversely charged toner image transferred to the surface of the recording medium, and a color forming unit that forms color of the toner image applied with the color forming information, the charged toner including a first component and a second component that are capable of forming the color upon reaction with each other, and are separated from each other in the toner, and a photo-curable composition containing at least one of the first component and the second component, the reaction for forming the color being controlled by maintaining a cured state or an uncured state of the photo-curable composition by application of color forming information with light.

### BACKGROUND

(1) Technical Field

The present invention relates to a toner capable of being colored in different colors through exposure with light having different wavelengths, and an image forming apparatus and an image forming method using the toner.

(2) Related Art

In a recording apparatus of obtaining a color image by an electrophotographic system, it has been practiced that development is carried out with image information of three primary colors to form toner images, which are sequentially accumulated to provide a color image. Specific examples of the constitution of the apparatus include a so-called four-cycle apparatus, in which one photoreceptor drum having a latent image formed thereon by an image forming method is developed for each of colors, and toner images are repeatedly transferred to a transfer member respectively to form a color image, and a tandem apparatus, in which photoreceptor drums and developing devices are provided for each of image forming units of respective colors, and toner images are sequentially transferred to a transfer member by moving the transfer member to obtain a color image.

These apparatuses commonly have plural developing devices for each of colors. Accordingly, four developing devices, i.e., three primary colors and black, are required for ordinary color image formation, and in the tandem apparatus, four photoreceptor drums are required for the four developing devices, respectively. The apparatuses cannot be avoided from increase in size and cost of the apparatuses since they are required to have, for example, a measure of synchronizing the four image forming units.

### SUMMARY

According to an aspect of the invention, there is provided an image forming apparatus including:

an image carrying member,

a toner feeding unit that forms a charged toner on a surface of the image carrying member,

a toner image forming unit that forms a reversely charged toner image by applying charge to the charged toner according to image information, the applied charge having a polarity contrary to the charged toner,

a color forming information applying unit that applies color forming information to the reversely charged toner image with light,

a transferring unit that transfers the reversely charged toner image to a surface of a recording medium,

a fixing unit that fixes the reversely charged toner image transferred to the surface of the recording medium, and

a color forming unit that forms color of the toner image applied with the color forming information,

the charged toner including a first component and a second component that are capable of forming the color upon reaction with each other, and are separated from each other in the toner, and a photo-curable composition containing at least one of the first component and the second component,

the reaction for forming the color being controlled by maintaining a cured state or an uncured state of the photo-curable composition by application of the color forming information with light.

### BRIEF DESCRIPTION OF THE DRAWINGS

An exemplary embodiment of the invention will be described in detail based on the following figures, wherein:

FIG. 1 is a schematic constitutional view showing an image forming apparatus according to a first exemplary embodiment of the invention;

FIG. 2 is a schematic constitutional view showing an image forming apparatus according to a second exemplary embodiment of the invention;

FIG. 3 is a circuit block diagram of a printer controller;

FIG. 4 is a schematic constitutional view showing an image forming apparatus according to another exemplary embodiment of the invention;

FIG. 5A is a schematic illustration showing a coloration mechanism of a toner in a coloring part;

FIG. 5B is a schematic illustration showing an enlarged view of FIG. 5A;

FIG. 6 is a schematic cross sectional view showing an exemplary embodiment of the toner structure (in the case where the toner contains a mother material and a photosensitive and heat-sensitive capsules dispersed in the mother material);

FIG. 7 is a schematic cross sectional view showing another exemplary embodiment of the toner structure (in the case where the toner has a concentric structure);

FIG. 8 is a schematic cross sectional view showing another exemplary embodiment of the toner structure (in the case where the toner has a stripe structure);

FIG. 9 is a schematic cross sectional view showing another exemplary embodiment of the toner structure (in the case where the toner has a flabellate structure); and

FIG. 10 is a schematic cross sectional view showing a state where a toner image is exposed to light for application of coloration image.

### DETAILED DESCRIPTION

The invention will be described with reference to the drawings. Members having substantially the same functions are applied with the same symbols, respectively, throughout the drawings to omit duplicate descriptions.

### First Embodiment

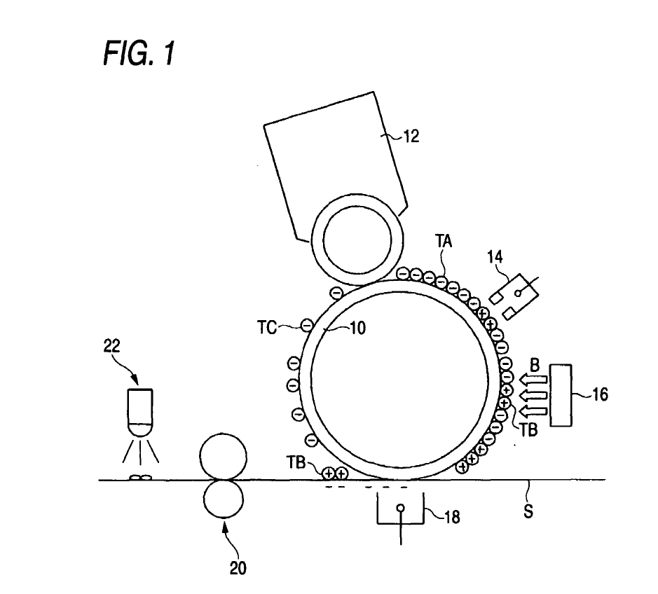

FIG. 1 is a schematic constitutional view showing an image forming apparatus according to a first exemplary embodiment of the invention.

The image forming apparatus according to the first exemplary embodiment contains, as shown in FIG. 1, an image carrying member 10 and, around the image carrying member 10, a toner recovering and feeding device 12 (toner recovering and feeding unit) that forms a negatively charged toner TA uniformly on the surface of the image carrying member 10 and recovering a remaining toner TC remaining on the image carrying member 10 through a transferring device 18, a toner image forming device 14 (toner image forming unit) that forms a positively charged toner image TB by applying charge, which has a polarity contrary to the negatively charged toner TA formed uniformly on the surface of the image carrying member 10, to the negatively charged toner TA, a color forming informationcolor forming information applying device 16 (color forming informationcolor forming information applying unit) that applies color forming informationcolor forming information to the positively charged toner image TB, and a transferring device 18 (transferring unit) that transfers the positively charged toner image TB to a surface of a recording medium S.

The apparatus further contains a fixing device 20 that fixes the positively charged toner image TB having been transferred to the surface of the recording medium S, with at least one of heat and pressure, and, on the downstream side of the fixing device 20, a light radiating device 22 (light radiating unit) that radiates light to the recording medium S to fix coloration of the positively charged toner image TB. The fixing device 20 also functions as a coloring device (coloring unit) that colors the toner image.

The toner has such a function that, for example, when each particle of the toner is irradiated with light having different wavelengths, for example, the toner is colored in colors corresponding to the wavelengths, respectively, or maintains a non-colored state.

In the image forming apparatus according to the exemplary embodiment using the toner, the negatively charged toner TA is formed uniformly on the image carrying member 10 (toner feeding step), and then the negatively charged toner TA is applied with positive charge with a logical sum of image formation information of four colors, for example, cyan (C), magenta (M), yellow (Y) and black (K), to form a positively charged toner image TB (toner image forming step). The positively charged toner image TB is then exposed to light having a wavelength corresponding to color information to apply color forming informationcolor forming information to the positively charged toner TB (color forming informationcolor forming information applying step). The positively charged toner image TB having been applied with the color forming informationcolor forming information is transferred and fixed to the recording medium S (transferring and fixing steps), the toner undergoes coloration reaction with heat before or after the transferring and fixing steps or simultaneously with the transferring and fixing steps (coloring step), and after fixing, the surface of the recording medium S is irradiated with light to remove and bleach the background color (light radiating step). The remaining toner TC remaining on the image carrying member 10 after transferring is recovered with the toner recovering and feeding device 12 (toner recovering step). Thus, a color image is obtained.

### Second Embodiment

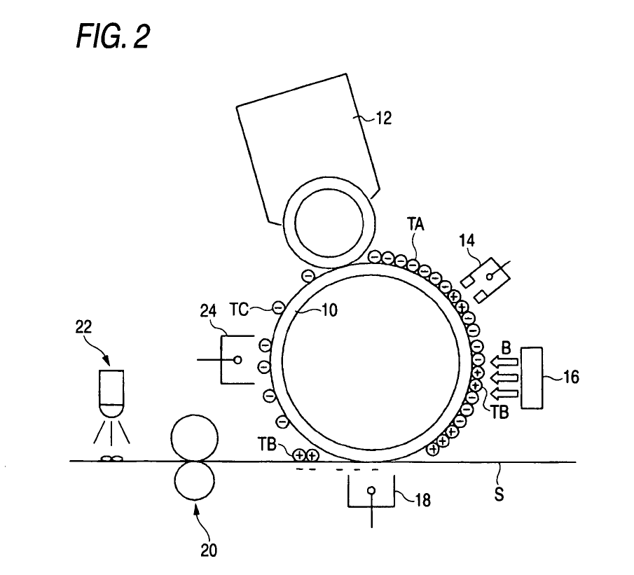

FIG. 2 is a schematic constitutional view showing an image forming apparatus according to a second exemplary embodiment of the invention.

The image forming apparatus according to the second exemplary embodiment has the same constitution as the first embodiment except that, as shown in FIG. 2, the apparatus contains, around the image carrying member 10, a toner recharging device 24 (toner recharging unit) that applies positive charge to the remaining toner TC remaining on the image carrying member 10 after transferring.

In the image forming apparatus according to the exemplary embodiment, since the toner positively charged through releasing discharge or the like after transferring is also contained in the remaining toner TC, the remaining toner is applied with negative charge (toner recharging step) to uniformize the charging property of the remaining toner to negative charge, whereby the recovering efficiency of the toner recovering and feeding device 12 can be improved.

In the exemplary embodiments, a negatively charged toner is formed uniformly, and an image of a positively charged toner is formed by applying positive charge to the negatively charged toner. However, the invention is not limited to the constitution, and it is possible that a positively charged toner is uniformly formed, and an image of a negatively charged toner is formed by applying negative charge to the positively charged toner.

The coloration mechanism of the toner for obtaining a color image with the image forming apparatus according the exemplary embodiments will be described.

The toner has one or more of continuous region, which is referred to as a coloring part, that is capable of being colored in a particular one color (or capable of maintaining a non-colored state) upon application of color forming informationcolor forming information with light.

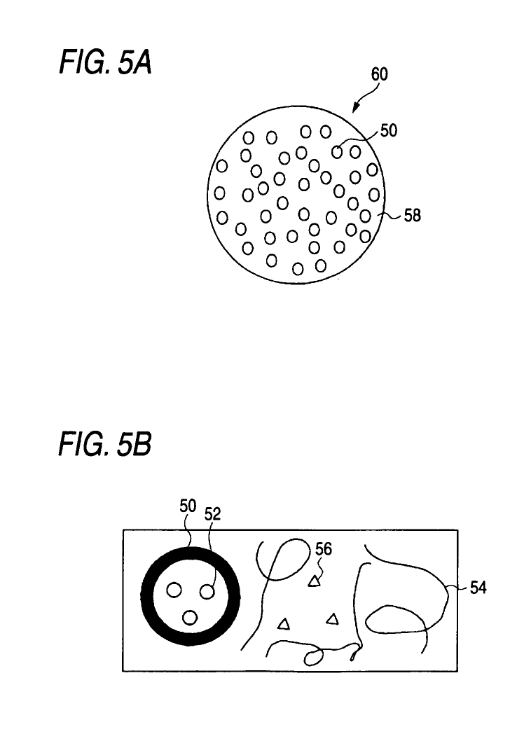

FIG. 5A is a schematic illustration showing a coloration mechanism of a toner in a coloring part, and FIG. 5B is a schematic illustration showing an enlarged view of FIG. 5A.

As shown in FIG. 5A, a coloring part 60 is constituted by coloring microcapsules 50 containing coloring agents of respective colors and a composition 58 surrounding the microcapsules 50, and as shown in FIG. 5B, the composition 58 contains a developer monomer (second component) 54 and a photopolymerization initiator 56, in which the developer monomer 54 has a polymerizable functional group capable of being colored through proximity or contact with a coloring agent (first component) 52 contained in the microcapsules 50.

In the coloring part 60, the coloring agent 52 sealed in the coloring microcapsules 50 may be a triaryl leuco compound excellent in brightness in coloration hue. The developer monomer 54 that colors the (electron donative) leuco compound may be an electron acceptive compound, and particularly a phenol compound is generally used, which may be appropriately selected from developers utilized in thermosensitive or pressure-sensitive paper. The coloring agent 52 is colored through acid-base reaction between the electron donative coloring agent 52 and the electron acceptive developer monomer 54.

The photopolymerization initiator 56 may be a spectral sensitizing dye that generates, upon exposure to visible light, a polymerizable radical functioning as a trigger of polymerization of the developer monomer 54. For example, a reaction accelerator for the photopolymerization initiator 56 is used for proceeding sufficiently polymerization reaction of the developer monomer 54 upon exposure to light of three primary colors, R color, G color and B color. Specifically, for example, by using an ion complex containing a spectral sensitizing dye (cation) absorbing exposure light and a boron compound (anion), the spectral sensitizing dye is excited with light upon exposure to cause electron transfer to the boron compound, whereby a polymerizable radical is formed to initiate polymerization.

According to the combination of these materials, the photosensitive coloring part 60 can provide a coloration recording sensitivity of about from 0.1 to 0.2 mJ/m².

Depending on the presence of light irradiation for color forming informationcolor forming information to the coloring part 60, the coloring part 60 in some portions has the polymerized developer compound, and in other portions has the developer monomer 54 having not been polymerized. In the coloring part 60 containing the developer monomer 54 having not been polymerized, the developer monomer 54 migrates with heat or the like in the subsequent coloring device, such as a heating device, to pass through pores in the wall of the coloring microcapsules 50, and is diffused inside the coloring microcapsules. The developer monomer 54 having been diffused inside the microcapsules 50 and the coloring agent 52 undergo the acid-base reaction to color the coloring agent 52 since the coloring agent 52 is basic and the developer monomer 54 is acidic.

The developer compound having undergone polymerization reaction cannot pass the pores in the wall of the microcapsules 50 to be diffused inside the microcapsules in the subsequent coloring step, such as heating, due to the bulky nature caused through polymerization, and cannot undergo reaction with the coloring agent 52 in the coloring microcapsules to fail to be colored. Accordingly, the coloring microcapsules 50 remain colorless. Consequently, the coloring part 60 that has been irradiated with light having a particular wavelength remains not being colored.

The entire surface is again exposed to white light in a suitable step after the coloration, whereby the remaining developer monomer 54 unpolymerized are entirely polymerized to attain stable image fixation, and the remaining spectral sensitizing dye are decomposed to decolorize the background. The color tone of the spectral sensitizing dye of the photopolymerization initiator 56 corresponding to visible region remains as a background color, and decoloration of the spectral sensitizing dye can be attained by photo-decoloration phenomenon of the dye and the boron compound. That is, electron transfer from the spectral sensitizing dye excited with light to the boron compound forms a polymerizable radical, and the radical induces polymerization of the monomer and simultaneously induces color decomposition of the dye through reaction with the excited dye radical to decolorize the dye finally.

In the toner, the coloring parts 60 exhibiting coloration in different colors (for example, coloration in Y color, M color and C color) are constituted within one microcapsule in such a state that the respective developer monomers 54 are not involved with other coloring agent than the target coloring agent 52, i.e., such a state that the respective developer monomers 54 are separated from each other. The toner containing such microcapsules that contains coloring agents 52 colored in plural different colors integrated therein is applied to a sole developing device to obtain a color image.

The use of the aforementioned toner provides a full color image with one image carrying member and one toner feeding device, and therefore, the size of the image forming apparatus is close to a monochrome printer without limitation to attain miniaturization of the apparatus. In addition, it is not necessary to accumulate toners of respective colors upon forming the positively charged toner image TB, and irregularity on the image surface can be suppressed to obtain uniform gloss on the image surface. Furthermore, no colorant, such as a pigment, is used in the toner, and thus an image equivalent to those obtained in the silver salt system can be obtained.

The mechanism of applying color forming informationcolor forming information to the toner is not reversible reaction as described later, and therefore, the toner to be colored to form a highlight image can be stably colored to a density of low tone or halftone. Accordingly, such an image with high quality can be formed that are formed with a current multicolor ink-jet printer. Furthermore, since the mechanism of applying color forming informationcolor forming information is not reversible reaction, such an advantage is obtained that there is no limitation in time in the period until the coloration by heating. As a result, printing operation can be attained at a low speed, i.e., the apparatus can be operated in a wide speed range, and also such an advantage is obtained that the degree of freedom in installation location of the fixing device effecting coloration by heating can be increased.

The constitution of the image forming apparatus according to the aforementioned exemplary embodiments will be described for respective steps in the image forming process.

### Toner Feeding Step

In the toner feeding step, a negatively charged toner TA is formed uniformly on the surface of the image carrying member 10 with the toner recovering and feeding device 12. The formation of the negatively charged toner on the image carrying member 10 is generally carried out by effecting uniform solid development by utilizing the ordinary developing method of a toner, whereby for example, a toner layer having a width equivalent to the width of the recording medium S is formed.

The toner layer formed on the image carrying member 10 (the amount of the toner attached to the image carrying member 10) is preferably in a range of from 3.5 to 8.0 g/m², and more preferably a range of from 4.0 to 6.0 g/m².

The thickness of the negatively charged toner TA formed on the image carrying member 10 may be controlled to a certain thickness or less since light for applying color forming informationcolor forming information described later is necessarily spread over the part having been exposed to the light. Specifically, for example, the toner layer preferably has three layers or less, and more preferably two layers or less. The thickness of the toner layer herein is a value obtained by dividing the measured thickness of the actual toner layer having been formed on the surface of the image carrying member 10 by the number average particle diameter of the toner.

Examples of the developing method of the toner include a two-component developing method using a toner and minute particles, which are referred to as a carrier, for carrying the toner, a one-component developing method using only a toner, and all the developing methods utilizing these developing methods, to which a constitutional substance for improving various properties, such as developing property, is separatedly added. A developing method effecting contact development of a developer to the image carrying member 10, a developing method effecting non-contact development, and any combination thereof may be used. A hybrid developing method using a combination of the one-component developing method and the two-component developing method may also be used. Moreover, any novel developing method, which will be invented in future, may be used.

A conductive medium may be used as the image carrying member 10, examples of which include a metallic drum containing a metallic simple tube having formed thereon a black conductive layer (antireflection layer, such as carbon). The image carrying member 10 is not limited thereto, and may be a drum or a belt having a resistance layer (such as an acrylate resin having carbon dispersed therein) having semiconductivity (such as a volume resistivity of from 10⁶ to 10¹⁰ Ωcm). In the case where the drum or belt having the semiconductive resistance layer is used, an excessive bias voltage is applied upon feeding the toner because a solid development is performed by utilizing development of the aforementioned electrophotographic system, but such an advantage is obtained that leakage difficulty occurs with the voltage.

The exposure for application of color forming informationcolor forming information described later is effected with a considerably strong intensity (the light energy for application of color forming informationcolor forming information is necessarily about 1,000 times the exposure amount (2 mJ/m²) for forming an electrostatic latent image used in an ordinary electrophotographic process), and in the case where a conductive medium such as the metallic drum is used as the image carrying member 10, the image carrying member 10 is prevented from being deteriorated due to exposure for application of color forming informationcolor forming information, whereby a color image can be stably obtained repeatedly for a prolonged period of time.

The toner recovering and feeding device 12 may be a toner developing device of an electrophotographic system, examples of which include a one-component developing device, a two-component developing device and a microtoning developing device, which have been known in the art.

The fed toner (negatively charged toner) is used as a toner supply in the device, and the one-component developer of an electrophotographic system or the two-component developer used in combination with a carrier may be used as the toner supply. Hereinafter, the toner supply may be referred to as a developer in some cases.

The toner contained in the toner supply (developer) may be, for example, a toner containing a coloring part capable of being colored in Y color (Y coloring part), a coloring part capable of being colored in M color (M coloring part) and a coloring part capable of being colored in C color (C coloring part) integrated in one toner particle, or a toner containing the Y coloring part, the M coloring part and the C coloring part in separate particles.

### Toner Image Forming Step

In the toner image forming step, positive charge is applied to the negatively charged toner TA having been uniformly charged, with the toner image forming device 14, so as to form an image of a positively charged toner (positively charged toner image TB).

The toner image forming device 14 may be, for example, an ion writing device using ion (ion writing unit). The ion writing device may be a ion stream control head utilizing a so-called ion stream system equipped with an ion generating source (such as a corona charging device) and a pair of control electrodes with a slit (control slit). In the ion stream control head, an ion (a positive ion in the exemplary embodiments) generated through corona discharge of the ion generation source (such as a corona charging device) is controlled into transit or non-transit of the ion stream with the direction of the electric field between the pair of control electrodes, whereby the ion is selectively applied to the uniformly formed toner to apply charge thereto.

The ion writing device (ion writing unit) is not limited to the aforementioned one, and may be a minute structure electrode head equipped with a pair of indirect electrodes and a control electrode that withdraws charge (electron and ion) generated through discharge between the indirect electrodes. In the minute structure electrode head, for example, charge (electron and ion) is generated through discharge between the pair of indirect electrodes by controlling the on/off state per one dot according to image signal, and the charge is withdrawn by the control electrode and applied selectively to the toner on the surface of the image carrying member 10. The minute structure electrode head can generate a large amount of charge (electron and ion) through discharge between the indirect electrodes, whereby the ion stream density can be largely improved, which is useful for speeding up the image forming process.

### Color Forming InformationColor Forming Information Applying Step

In the color forming informationcolor forming information applying step, color forming informationcolor forming information is applied to the positively charged toner image TB with light shown by the arrow B by using the color forming informationcolor forming information applying device 16. The term “application of color forming informationcolor forming information with light” referred herein means that in order to control the colored/non-colored state or the color tone upon coloration per individual toner particles constituting the positively charged toner image TB, a desired area of the positively charged toner image TB is applied with light having one or more particular wavelength or is applied with no light. The position of the color forming informationcolor forming information applying step may be after the transferring step, as described later.

The color forming informationcolor forming information applying device 16 is not limited as far as it can radiate light having a wavelength for coloring the toner particle to be colored in the particular color, at prescribed resolution and intensity. Examples thereof include an LED image bar and a laser ROS. The radiation spot diameter of the light radiated onto the positively charged toner image TB is preferably controlled to a range of from 10 to 300 μm, and more preferably in a range of from 20 to 200 μm, for obtaining an image having a resolution of from 100 to 2,400 dpi.

The wavelength of the light used for coloring or maintaining a non-colored state is determined by the material design of the toner used, and for example, in the case where a toner colored through irradiation of light having a particular wavelength (light coloring type toner) is used, light having a wavelength of 405 nm (hereinafter, referred to as λ_{A} light) is radiated to a desired position to be colored in yellow (Y color), light having a wavelength of 535 nm (hereinafter, referred to as λ_{B} light) is radiated to a desired position to be colored in magenta (M color), and light having a wavelength of 657 nm (hereinafter, referred to as λ_{C} light) is radiated to a desired position to be colored in cyan (C color).

In the case where the toner is colored in secondary colors, by using combinations of the aforementioned light, the λ_{A} light and the λ_{B} light are radiated to a desired position to be colored in red (R color), the λ_{A} light and the λ_{C} light are radiated to a desired position to be colored in green (G color), and the λ_{B} light and the λ_{C} light are radiated to a desired position to be colored in blue (B color). In the case where the toner is colored in black (K color) as a tertiary color, the λ_{A} light, the λ_{B} light and the λ_{C} light are radiated to a desired position to be colored in black.

In the case where the toner maintaining a non-colored state upon irradiation of light having a particular wavelength (light non-coloring type toner) is used, light having a wavelength of 405 nm (λ_{A} light) is radiated to a desired position to be not colored in yellow (Y color), light having a wavelength of 535 nm (λ_{B} light) is radiated to a desired position to be not colored in magenta (M color), and light having a wavelength of 657 nm (λ_{C} light) is radiated to a desired position to be not colored in cyan (C color). Accordingly, the λ_{B} light and the λ_{C} light are radiated to a desired position to be colored in Y color, the λ_{A} light and the λ_{C} light are radiated to a desired position to be colored in M color, and the λ_{A} light and the λ_{B} light are radiated to a desired position to be colored in C color.

In the case where the toner is colored in secondary colors, by using combinations of the aforementioned light, the λ_{C} light is radiated to a desired position to be colored in red (R color), the λ_{B} light is radiated to a desired position to be colored in green (G color), and the λ_{A} light is radiated to a desired position to be colored in blue (B color). In the case where the toner is colored in black (K color) as a tertiary color, no light is radiated to a desired position to be colored in black.

The light from the color forming informationcolor forming information applying device 16 may be subjected to known image modulation method depending on necessity, such as pulse width modulation, intensity modulation, and a combination thereof. The exposure amount of the light is preferably in a range of from about 0.05 to about 0.8 mJ/m², and more preferably a range of from about 0.1 to about 0.6 mJ/m². The exposure amount has relationship to the amount of the developed toner, and for example, in the case of a developed toner amount (solid) of about 5.5 g/m², exposure in a range of from about 0.2 to about 0.4 mJ/m² is preferably effected.

Since the application of color forming informationcolor forming information is effected from only one side of the image carrying member 10, the light is difficult to reach the lower layer part of the toner developed in multilayer to fail to obtain sufficient coloration, and as a result, the intended color in the image might not be obtained in some cases. In the invention, accordingly, the image carrying member 10 may be equipped with a reflecting unit that reflects the exposure light of applying color forming informationcolor forming information to the positively charged toner TB formed on the image carrying member 10.

The reflecting unit reflecting the exposure light can be provided by making the metallic drum as the image carrying member to have a mirror surface. The metallic drum having a mirror surface preferably has an arithmetic average roughness Ra according to JIS B0601 of 12.5 μm or less. The reflection ratio of the exposure light upon providing the reflecting unit is preferably 70% or more, and more preferably 90% or more.

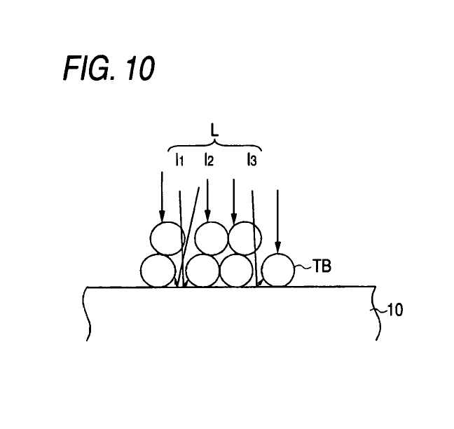

FIG. 10 is a schematic cross sectional view of the image carrying member 10 carrying the positively charged toner TB upon exposure for application of color forming informationcolor forming information, in which in the case where the positively charged toner TB (toner layer) formed on the image carrying member 10 is exposed to exposure light (shown by the arrows L in the figure) for application of color forming informationcolor forming information, about from 10 to 50% of the light reaches the image carrying member 10 through the toner itself or gaps in the toner layer. Accordingly, the light reaching the image carrying member 10 is reflected with the reflecting unit (i.e., the surface of the image carrying member 10) as shown by the symbols l₁ to l₃ to expose the toner, whereby the positively charged toner TB developed in multilayer can be exposed from the side of the lower layer to attain sufficient exposure for application of color forming informationcolor forming information, and as a result, sufficient coloration can be obtained to provide the intended color in the image.

In the case where the exposure light is laser light, the incident angle of the laser beam onto the image carrying member 10 is necessarily tilted by several degree (in general, from 4 to 13 degree) for preventing returned light to the photodetector of the laser in ordinary cases, but upon application of color forming information, returned light is absorbed with the toner to reduce the returned light significantly, whereby the laser beam may be incident at an arbitrary angle including 0 degree.

The timing and positional control of the exposure for application of color forming information will be described below along with the ion writing for forming the toner image.

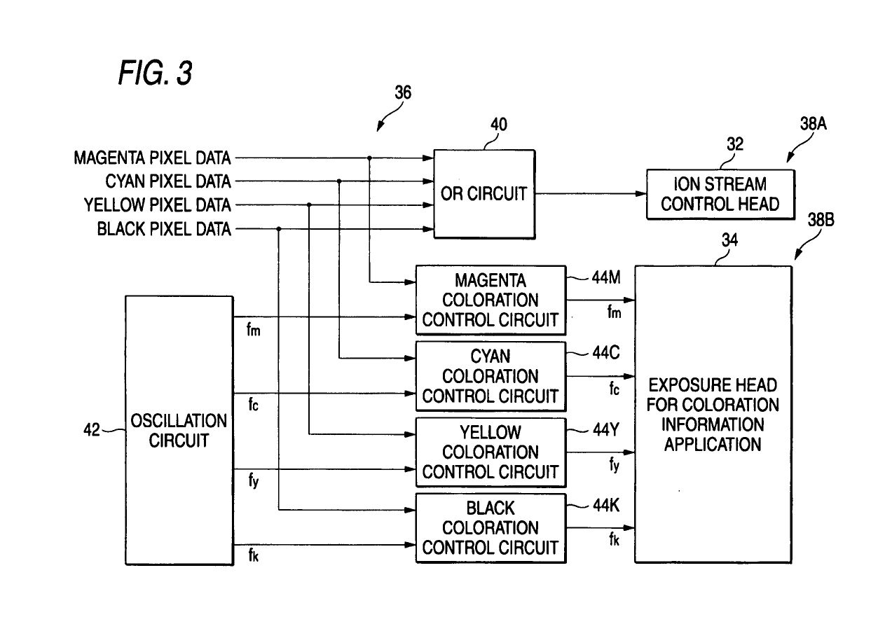

FIG. 3 is a circuit block diagram of a printer controller. In the figure, a printer controller 36 is constituted by an OR circuit 40, an oscillation circuit 42, a magenta coloration control circuit 44M, a cyan coloration control circuit 44C, a yellow coloration control circuit 44Y and a black coloration control circuit 44K. The image forming part 38A is constituted by an ion stream control head 32 (toner image forming unit), and the color forming information applying part 38B is constituted by an exposure head for color forming information application 34.

An RGB signal input from an interface (I/F), which is not shown in the figure, is converted to CMYK values as image data, and is further output to the OR circuit 40 as pixel data of magenta (M), cyan (C), yellow (Y) and black (K). The OR circuit 40 calculates a logical sum of CMYK, which is then output to the ion stream control head 32.

The data of logical sum containing all the pixel data of CMYK is output to the ion stream control head 32 to effect ion writing with positive ion to the negatively charged toner formed on the image carrying member 10 as having been described. Accordingly, on the negatively charged toner uniformly formed on the image carrying member 10, a positively charged toner image TB is formed based on the logical sum data containing all the pixel data of CMYK.

The pixel data of CMYK are also fed to the magenta coloration control circuit 44M, the cyan coloration control circuit 44C, the yellow coloration control circuit 44Y and the black coloration control circuit 44K, and then output to the exposure head for color forming information application as being synchronized with the oscillation signals fm, fc, fy and fk output from the oscillation circuit 42. Accordingly, the coloration data corresponding to magenta (M), cyan (C), yellow (Y) and black (K) are fed to the exposure head for color forming information application 34, and light having a particular wavelength for coloring or maintaining a non-colored state is radiated to the positively charged toner image TB formed on the image carrying member 10. Consequently, photocuring reaction, which will be described later, occurs in the toner receiving the irradiated light to complete the application of color forming information.

For example, the coloration signal fm output from the magenta coloration control circuit 44M operates radiation of the λ_{B} light to the coloring part in the toner, whereby the toner is made into a state capable of being colored in magenta (M) color. The coloration signal λ_{C} output from the cyan coloration control circuit 44C operates radiation of the λ_{C} light to the coloring part in the toner, whereby the toner is made into a state capable of being colored in cyan (C) color. The same operation is effected for yellow (Y) and black (K) colors, and the coloration signals fy and fk output from the yellow coloration control circuit 44Y and the black coloration control circuit 44K operate radiation of the λ_{A} light, and the λ_{A} light, the λ_{B} light and the λ_{C} light, respectively, to the coloring parts in the toner, whereby the toner is made into states capable of being colored in yellow (Y) color and black (K) color, respectively.

The color forming information applying step (unit) has been described for the mechanism of forming a full color image, but the color forming information applying step may be such a color forming information applying step that forms a monochrome image through coloration in one of yellow, magenta and cyan colors. In this case, the exposure head for color forming information application 34 radiates only light having a particular wavelength corresponding to coloration of a desired color among yellow, magenta and cyan colors. The other conditions may be the same as those in the formation of a full color image.

In the aforementioned exemplary embodiments, the color forming information applying step is carried out after the formation of the toner image before transferring the toner image, but the color forming information applying step may be at least before the fixing step, and may be carried out, for example, after the transferring step described later. However, the exposure for applying color forming information may be carried out after the formation of the toner image before transferring the toner image from the standpoint of the flatness on the surface of the recording medium, and the accuracy of coloration positions of the desired image.

The positively charged toner image TB in this stage remains in the original color thereof but not being colored, and the positively charged toner image TB containing a sensitizing dye if any only has the color of the sensitizing dye.

In the case using the light non-coloring type toner, the color forming information applying step (unit) may not be used for forming only a monochrome image. Therefore, a recording apparatus for forming a monochrome image is firstly provided, and upon increasing the demand of color images, the apparatus may be added with the color forming information applying units to expand to a color image forming apparatus.

### Transferring Step

In the transferring step, the positively charge toner image TB having been applied with color forming information is transferred at once to the recording medium S with the transferring device 18. At this time, while the transferred area contains the negatively charged toner and the positively charged toner having been formed imagewise, negative charge is applied to the back side of the recording medium S with the transferring device 18, whereby only the positively charged toner, i.e., only the positively charged toner image TB, is electrostatically transferred to the surface of the recording medium S.

The transferring device 18 may be a known transferring device. Examples of the transferring device of the contact system include a roll, a brush and a blade, and examples thereof of the non-contact system include a corotron, a scorotron and a pin scorotron. The non-contact system may be employed owing to the transfer operation of electrostatically transferring only the toner charged to the reverse polarity among the toner over the entire surface of the image carrying member, and the corona transfer bias is preferably in a range of from 5 to 8 kV in terms of absolute value.

### Fixing Step and Coloring Step

In the fixing step and the coloring step, the positively charged toner image TB in a state capable of being colored (or capable of maintaining a non-colored state) undergoes coloration by heating the recording medium S with the fixing device 20. The fixing device 20 may be a known fixing unit. Examples thereof include a roll and a belt as a heating member and a pressurizing member, and a halogen lamp and an IH heater as a heat source. The arrangement thereof may be various kinds of paper pass, such as straight pass, rear C pass, front C pass, S pass, and side C pass.

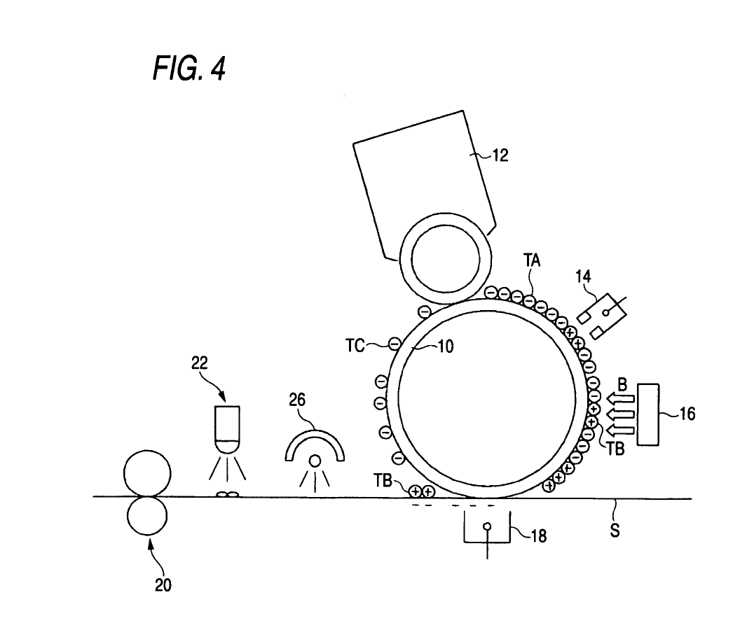

In the aforementioned exemplary embodiments, the fixing device 20 functions as both the coloring step and the fixing step, and the coloring step may be provided separately from the fixing step. The position where the coloring device for carrying out the coloring step is disposed is not particularly limited, and for example, as shown in FIG. 4, the coloring device 26 and the light radiating device 22 may be disposed on the upstream side of the fixing device 20. According to the configuration, the heating temperature for coloration and the heating temperature for fixing the toner to the recording medium S can be separately controlled, whereby the degree of freedom in designing the coloring material and the toner binder material can be improved.

In this case, various methods may be considered for the coloring method depending on the coloration mechanism of the toner particles, and therefore, examples of the coloring device 26 (coloring unit) that can be used include a luminescent device radiating particular light for the method of curing or photo-decomposing a substance participating coloration in the toner by using the particular light having a different wavelength to effect or suppress coloration, and a pressurizing device for the method of breaking capsulated coloring particles by pressure to effect or suppress coloration.

However, the chemical reaction for coloration generally has a slow reaction rate of migration or diffusion, and sufficient diffusion energy is necessarily imparted in both the aforementioned methods. Therefore, the method of accelerating the reaction by heating may be used herein, and the fixing device 20 functioning both the coloring step and the fixing step may be used for space saving.

### Light Radiating Step

In the light radiating step, the image obtained through the fixing and coloring steps is irradiated with light using the light radiating device 22. According to the operation, the reactive substance remaining in the coloring part having been controlled to a state incapable of being colored can be decomposed or deactivated, whereby the color balance after forming the image can be certainly suppressed from being fluctuated, and the background color can be removed or bleached.

In the aforementioned exemplary embodiments, the light radiation step is provided after the fixing step, but in the case of the fixing step effecting no heat-melting operation, such as the pressurizing fixing step of fixing the image with pressure, the fixing step may be carried out after the light radiation step.

The light radiating device 22 is not particularly limited as far as it can terminate the progress of coloration of the toner, and examples thereof include a known lamp, such as a fluorescent lamp, an LED and an EL lamp. The wavelength of the light may contain the three wavelengths for coloring the toners. The illuminance thereof is preferably in a range of about from 2,000 to 200,000 lux, and the exposure time is preferably in a range of from 0.5 to 60 seconds.

### Toner Recovering Step

In the toner recovering step, the remaining toner TC remaining on the image carrying member 10 after transferring with the transferring device 18 is recovered with the toner recovering and feeding device 12. While not shown in the figures, the recovery of the remaining toner with the toner recovering and feeding device 12 is effected by electrically moving the remaining toner toward a toner feeding roller, which is not shown in the figures, disposed to face the image carrying member 10, and scraping the remaining toner inside the device. According to the operation, no device is required for cleaning the remaining toner TC to realize the so-called cleanerless system.

### Toner Recharging Step

In the toner recharging step, the remaining toner TC remaining on the image carrying member 10 after transferring with the transferring device 18 is applied with charge having the same polarity to the negatively charged toner TA, with the toner recharging device 24. According to the operation, recovery of the remaining toner TC with the toner recovering and feeding device 12 can be efficiently carried out.

The toner recharging device 24 may be a known charging device for the electrophotographic system. Examples of the toner recharging device of the contact system include a roll, a brush, a magnetic brush and a blade, and examples thereof of the non-contact system include a corotron and a scorotron. According to the operation, the remaining toner TC can be prevented from suffering excessive charging, and the repetition stability of the image forming process can be improved.

### Other Steps

In addition to the aforementioned steps, known steps may be contained that have been utilized in the electrophotographic system carried out by using a colorant, such as a pigment, and for example, a cleaning step of cleaning the surface of the image carrying member after transferring the positively charged toner image TB may be contained. The cleaner may be a known one, examples of which include a blade and a brush.

Furthermore, an intermediate transfer system may be employed as the transferring step, which contains a first transferring step of transferring the positively charged toner image TB from the image carrying member 10 to an intermediate transfer material, such as an intermediate transfer belt, and a second transferring step of transferring the positively charged toner image TB transferred to the intermediate transfer material to the recording medium.

As having been described, the color forming information is stably retained within the period of from the color forming information applying step, where the color forming information is applied, to the coloring step. Accordingly, the time from the color forming information applying step to the coloring step may not be considered, and the apparatus can be operated in a wide speed range. Specifically, the linear velocity is preferably in a range of from 10 to 500 mm/sec, and more preferably a range of from 50 to 300 mm/sec. In the case where image formation is carried out at a linear velocity within the range, however, the exposure time for applying color forming information may be set to a value determined from the linear velocity and the resolution.

The stable retention of color forming information exerts excellent effect to the color tone stability of an image and the reproducibility of a highlight image, and thus greatly contributes to formation of a full color image capable of faithfully reproducing the input image information with high image quality.

### Toner Used

The constitution of the toner used in the invention will be described.

As having been described, the toner in the invention contains the first component and the second component that are capable of being colored upon reaction with each other, and are separated from each other in the toner, and a photo-curable composition containing one of the first component and the second component, and the reaction for coloration is controlled by maintaining a cured state or an uncured state of the photo-curable composition by application of color forming information with light. The mechanism of coloration of the toner has been described hereinabove.

The toner in the invention contains, as substances capable of being colored (coloring substances), the first component and the second component that are capable of being colored upon reaction with each other, and are separated from each other in the toner. The coloration is effected by utilizing reaction between two kinds of reactive components, whereby the coloration can be easily controlled. The first component and the second component may be colored in advance before coloration, but may be substantially colorless substances.

In the invention, the two kinds of reactive components capable of being colored upon reaction with each other are used in order to facilitate control of coloration, but in the case where the reactive components are present in the same matrix facilitating diffusion of substances even in the state where no color forming information with light is applied, spontaneous coloration might occur upon storage or production of the toner in some cases.

Accordingly, it is necessary that the reactive components are contained in different matrices, between which diffusion of substances is difficult to occur unless color forming information is applied thereto (i.e., the reactive components are separated from each other).

In order that diffusion of substances is inhibited in the state where color forming information is not applied with light to prevent spontaneous coloration upon storage and production of the toner from occurring, such a constitution may be employed that the first component of the two kinds of reactive components is contained in the first matrix, the second component thereof is contained outside the first matrix (in the second matrix), and a wall having such a function is provided between the first matrix and the second matrix that diffusion of substances between the matrices is inhibited, but upon application of external stimulation, such as heat, diffusion of substances between the matrices is enabled corresponding to the kind, intensity and combination of the stimulation.

In order to dispose the two kinds of reactive components in the toner by utilizing the wall, microcapsules may be used.

In this case, such a constitution may be employed that the toner in the invention contains the first component of the two kinds of reactive components contained in microcapsules, and the second component contained outside the microcapsules. In this case, the interior of the microcapsules corresponds to the first matrix, and the exterior of the microcapsules corresponds to the second matrix.

The microcapsules are not particularly limited, as far as they have a core and an outer shell covering the core, and have such a function that diffusion of substances is inhibited between the interior and exterior of the microcapsules unless external stimulation, such as heat, is applied, but upon application of external stimulation, such as heat, diffusion of substances is enabled between the interior and exterior of the microcapsules corresponding to the kind, intensity and combination of the stimulation. The core contains at least one of the reactive components.

The microcapsules may enable diffusion of substances between the interior and exterior of the microcapsules by application of stimulation, such as irradiation with light or application of pressure, and may be heat-responsive microcapsules capable of enabling diffusion of substances between the interior and exterior of the microcapsules (i.e., the permeability of substances of the outer shell is increased) by a heat treatment.

The diffusion of substances between the interior and exterior of the microcapsules upon application of stimulation may be irreversible from the standpoint that the coloration density upon forming an image is suppressed from being decreased, and the color balance of an image allowed to stand in a high temperature environment is suppressed from being changed. Accordingly, the outer shell constituting the microcapsules may have such a function that the permeability of substances is irreversibly increased through softening, decomposition, dissolution (dissolution into the surrounding materials), deformation or the like, invoked by application of stimulation, such as a heat treatment and irradiation with light.

An exemplary embodiment in the case where the toner contains microcapsules will be described.

The toner may contain the first component and the second component that are capable of being colored upon reaction with each other, microcapsules, and a photo-curable composition containing the second component dispersed therein, and examples thereof include the following three exemplary embodiments.

Accordingly, in the toner in the invention containing the first component and the second component that are capable of being colored upon reaction with each other, and are separated from each other in the toner, and a photo-curable composition containing one of the first component and the second component, when the toner further contains microcapsules, the following three exemplary embodiments may be employed: (1) an embodiment containing microcapsules dispersed in a photo-curable composition, where the first component is contained in the microcapsules, and the second component is contained in the photo-curable composition (hereinafter, referred to as a first embodiment in some cases), (2) an embodiment where the second component is contained in the microcapsules, and the first component is contained in the photo-curable composition (hereinafter, referred to as a second embodiment in some cases), and (3) an embodiment where both the first and second components are contained in two kinds of microcapsules, respectively, and the photo-curable composition is contained in one of the two kinds of microcapsules containing the first and second components (hereinafter, referred to as a third embodiment in some cases).

Among the three embodiments, the first embodiment is preferred from the standpoint of stability before application of color forming information with light and control of coloration. The following description with respect to the toner will be made mainly for the toner of the first embodiment, and the constitutions, materials, production methods and the like of the toner of the first embodiment may be applied to the toners of the second and third embodiments.

### Microcapsules

The microcapsules may be heat-responsive microcapsules capable of enabling diffusion of substances between the interior and exterior of the microcapsules by a heat treatment, and in this case, the external stimulation may be a combination containing the presence of irradiation of light applying color forming information (application of control stimulation) and a heat treatment (application of coloring stimulation) when the photo-curable composition is cured by irradiation with light applying color forming information.

In this case, accordingly, the external stimulation applied for carrying out control of reaction between the first and second components (control of coloration reaction) contains coloration stimulation invoking reaction between the first and second component (coloration reaction) in the state capable of being reacted, and control stimulation controlling reaction between the first and second component (coloration reaction) before application of the coloration stimulation into a state capable of or incapable of being colored upon application of the coloration stimulation, in which irradiation of light applying color forming information is used as the control stimulation, and a heat treatment is used as the coloration stimulation.

The heat-responsive microcapsules (hereinafter, referred simply to as microcapsules) is constituted by the core containing the first component and the outer shell covering the core, and the material constituting the outer shell may contain a heat-responsive material capable of enabling diffusion of substances between the interior and exterior of the microcapsules by a heat treatment. In this case, the heat-responsive material used as the outer shell of the microcapsules may be such a material that undergoes decomposition, disappearance, breakage or the like of the outer shell structure after completing the heat treatment through decomposition, softening, dissolution into the surrounding materials, or the like by the heat treatment, so as to maintain permanently (irreversibly) the state facilitating diffusion of substances between the interior and exterior of the microcapsules (for example, a heat-decomposing material capable of being decomposed by heating, a thermoplastic material, such as a thermoplastic resin, and a heat-dissolution material capable of being dissolved into the surrounding materials by heating).

According to the constitution, the permeability of substances of the outer shell of the microcapsules is irreversibly increased in the coloring step, and the state is maintained, whereby the first component and the second components having been in a state capable of being reacted after application of the control stimulation (irradiation with light applying color forming information) can be easily reacted with each other completely. Consequently, a sufficient coloration density can be ensured in the coloring step, and furthermore, even in the case where a printed matter after forming an image is allowed to stand in a high temperature environment, the image once formed is suppressed from suffering disruption of color balance due to discoloration.

### Coloration Type of Toner (Light Coloring Type and Light Non-Coloring Type)

The toner in the invention using the heat-responsive microcapsules and the photo-curable composition in combination may be one of the following two types: (1) such a toner that maintains a state incapable of being colored when the photo-curable composition is in an uncured state, and is controlled irreversibly from the state incapable of being colored to a state capable of being colored by curing the photo-curable composition through irradiation of light having a particular wavelength capable of curing the photo-curable composition (hereinafter, referred to as a light coloring type toner in some cases), and (2) such a toner that maintains a state capable of being colored when the photo-curable composition is in an uncured state, and is controlled irreversibly from the state capable of being colored to a state incapable of being colored by curing the photo-curable composition through irradiation of light having a particular wavelength capable of curing the photo-curable composition (hereinafter, referred to as a light non-coloring type toner in some cases).

The major difference between the light coloring type toner and the light non-coloring toner resides in the material constituting the photo-curable composition. In the light coloring type toner, the photo-curable composition contains at least the second component (having no photopolymerizability) and a photopolymerizable compound, whereas in the light non-coloring type toner, the photo-curable composition contains at least the second component having a photopolymerizable group in the molecule thereof.

The photo-curable composition used in the light coloring type toner and the light non-coloring toner may contain a photopolymerization initiator, and may further contain other various materials depending on necessity.

As the photopolymerizable compound and the second component used in the light coloring type toner, such a material is used that mutual interaction occurs between them in the state where the photo-curable composition is uncured, so as to suppress the second component from being diffused in the photo-curable composition, and the mutual interaction between them is reduced in the state after the photo-curable composition is cured (polymerization of photopolymerizable compound) by irradiation with light applying color forming information, so as to facilitate diffusion of the second component in the photo-curable composition. The materials constituting the photo-curable composition will be described in detail later.

Accordingly, in the light coloring toner in such a state that the photo-curable composition is uncured without irradiation with light applying color forming information, the second component remains trapped by the photopolymerizable compound. Therefore, even when stimulation increasing the permeability of substances of the outer shell of the microcapsules is applied thereto in this state, the second component cannot be made in contact with the first component in the microcapsules, thereby maintaining the state where reaction between the first component and the second component (coloration reaction) cannot proceed (i.e., the state incapable of being colored).

When the photo-curable composition is cured by irradiating with light applying color forming information having a wavelength capable of curing the photo-curable composition, on the other hand, diffusion of the second component contained in the photo-curable composition is facilitated. Therefore, the permeability of substances of the outer shell of the microcapsules is increased by applying coloration stimulation, such as a heat treatment, thereby providing the state where reaction between the first component in the microcapsules and the second component in the photo-curable composition (coloration reaction) proceeds (i.e., the state capable of being colored).

Since the curing reaction of the photo-curable composition is irreversible reaction, when the state capable of being colored is once provided, the state is permanently maintained.

Accordingly, in the case, for example, where heat-responsive microcapsules are used as the microcapsules, the photo-curable composition is cured by irradiating with light applying color forming information to control the toner into the state capable of being colored, and then the toner is subjected to a heat treatment, whereby the permeability of substances of the outer shell of the microcapsules is increased to invoke reaction between the first component and the second component, thereby coloring the toner in a prescribed color, and the colored state is stably maintained. In the case where light applying color forming information capable of curing the photo-curable composition is not radiated, on the other hand, the photo-curable composition continuously maintains the uncured state, and therefore, the first component and the second component cannot be reacted with each other even though the toner is subjected to a heat treatment to increase the permeability of substances of the outer shell of the heat-responsive microcapsules. Consequently, in the case where the toner before coloration is transparent and colorless, the transparent and colorless state is stably maintained.

In the light coloring type toner described above, the coloration reaction between the first component and the second component is controlled by two steps, i.e., (1) the curing reaction of the photo-curable composition by irradiation with light applying color forming information having a wavelength capable of curing the photo-curable composition, and (2) the increase of the permeability of substances of the outer shell of the microcapsules by application of coloration stimulation, such as a heat treatment.

The coloration reaction of a toner utilizing a photo-responsive two-molecular film as a capsule wall as described in JP-A-2003-330228 also contains two steps, i.e., a state capable of undergoing coloration reaction (diffusion of substances) is obtained by irradiation with light, and then the diffusion of substances is facilitated by heating to effect reaction.

However, the first step reaction, which determines as to whether or not the state incapable of being colored is controlled to the state capable of being colored, (i.e., the curing reaction of the photo-curable composition) in the light coloring type toner is irreversible reaction, but the first step reaction of the toner disclosed in JP-A-2003-330228 is reversible reaction.

In the toner disclosed in JP-A-2003-330228, accordingly, the coloration reaction as the second step reaction comes under influence of the first step reaction in certain extent since the first step reaction is reversible reaction, and thus the coloration reaction is difficult to control. Consequently, the coloration density upon forming an image might be fluctuated.

In the light coloring type toner, on the other hand, the coloration reaction as the second step reaction can be controlled without influence of the first step reaction to facilitate control of the coloration reaction, whereby the coloration density upon forming an image can be easily ensured, and the color balance after forming an image can be easily suppressed from being fluctuated. Furthermore, the increase of the permeability of substances of the outer shell of the microcapsules is exerted irreversibly, whereby the coloration reaction can be controlled precisely. Moreover, the gradation of the coloration density can be controlled by the extent of curing (polymerization) of the photo-curable composition, which is irreversible reaction, whereby the gradation of the coloration density can be easily controlled.

The light coloring type toner may be, in addition to the aforementioned toner using the photopolymerizable compound capable of trapping the second component in the state where the photo-curable composition is uncured (hereinafter, referred to as a first light coloring type toner in some cases), a toner using a photopolymerizable compound having, in the molecule thereof, a decoloration reaction group capable of inhibiting the coloration reaction between the first component and the second component through reaction with the first component (hereinafter, referred to as a second light coloring type toner).

In the second light coloring toner, in the case, for example, where heat-responsive microcapsules are used as the microcapsules, when the photo-curable composition is cured (i.e., the photopolymerizable compound having a decoloration reaction group is polymerized) by irradiating with light applying color forming information having a wavelength capable of curing the photo-curable composition, and the heat treatment is carried out, the coloration reaction between the first component and the second component is not inhibited with the decoloration reaction group (diffusion upon heating of which is disabled by polymerization), thereby enabling coloration. In the case where the heat treatment is carried out without irradiation with light applying color forming information having a wavelength capable of curing the photo-curable composition, on the other hand, the decoloration reaction group is reacted with the first component to inhibit the coloration reaction between the first component and the second component, thereby disabling coloration.

As having been described, in the second light coloring type toner, a state incapable of being colored is maintained when the photo-curable composition is uncured, and the state incapable of being colored is controlled to a state capable of being colored by curing the photo-curable composition by irradiation with light having a particular wavelength capable of curing the photo-curable composition.

In the light non-coloring type toner, the second component itself has photopolymerizability, and therefore, even though light applying color forming information is radiated, the state where the diffusion of the second component contained in the photo-curable composition is facilitated is maintained unless the wavelength of the irradiated light is a wavelength capable of curing the photo-curable composition. Accordingly, when the permeability of substances of the outer shell of the microcapsules is increased in this state by applying coloration stimulation, such as a heat treatment, such a state is obtained that reaction between the first component in the microcapsules and the second component in the photo-curable composition (coloration reaction) is enabled (i.e., the state capable of being colored).

In the case where the photo-curable composition is cured by irradiating with light applying color forming information having a wavelength capable of curing the photo-curable composition, on the other hand, the second component contained in the photo-curable composition is polymerized, whereby the diffusion of the second component contained in the photo-curable composition becomes significantly difficult. Accordingly, even though stimulation increasing the permeability of substances of the outer shell of the microcapsules is applied, the second component cannot be in contact with the first component in the microcapsules, whereby such a state is maintained that reaction between the first component in the microcapsules and the second component in the photo-curable composition (coloration reaction) is disabled (i.e., the state incapable of being colored).

Since the curing reaction of the photo-curable composition is irreversible reaction, when the state incapable of being colored is once provided, the state is permanently maintained.

Accordingly, in the case, for example, where heat-responsive microcapsules are used as the microcapsules, the photo-curable composition is cured by irradiating with light applying color forming information to control the toner into the state incapable of being colored, whereby the first component and the second component cannot undergo reaction even though the toner is subjected to a heat treatment to increase the permeability of substances of the outer shell of the heat-responsive microcapsules. Consequently, in the case where the toner before coloration is transparent and colorless, the transparent and colorless state is stably maintained.

In the case where the toner is subjected to a heat treatment in the state where the photo-curable composition is uncured, i.e., the state capable of being colored, on the other hand, the permeability of substances of the outer shell of the heat-responsive microcapsules is increased to invoke reaction between the first component and the second component, thereby coloring the toner in a prescribed color, and the colored state can be stably maintained.

In the light non-coloring type toner described above, the coloration reaction between the first component and the second component is controlled by substantially one step of increasing the permeability of substances of the outer shell of the heat-responsive microcapsules by applying coloration stimulation, such as a heat treatment, in the state where the photo-curable composition is uncured (i.e., the state without irradiation with light applying color forming information having a wavelength capable of curing the photo-curable composition).

Accordingly, the coloration reaction can be easily controlled, whereby the coloration density upon forming an image can be easily ensured, and the color balance after forming an image can be easily suppressed from being fluctuated. Furthermore, the increase of the permeability of substances of the outer shell of the microcapsules is exerted irreversibly, whereby the coloration reaction can be controlled precisely. Moreover, the gradation of the coloration density can be controlled by the extent of curing (polymerization) of the photo-curable composition, which is irreversible reaction, whereby the gradation of the coloration density can be easily controlled.

In the case where the toner is intended to be not colored, light applying color forming information is radiated to cure the photo-curable composition before increasing the permeability of substances of the outer shell of the microcapsules by applying coloration stimulation, such as a heat treatment, whereby the state incapable of being colored can be stably maintained.

On the other hand, the coloration reaction of a toner utilizing a photo-responsive two-molecular film as a capsule wall as described in JP-A-2003-330228 contains two steps, i.e., a state capable of undergoing coloration reaction (diffusion of substances) is obtained by irradiation with light, and then the diffusion of substances is facilitated by heating to effect reaction, and therefore, it contains a complicated control operation for coloration. Furthermore, in the toner disclosed in JP-A-2003-330228, the coloration reaction as the second step reaction comes under influence of the first step reaction in certain extent since the first step reaction is reversible reaction, and thus the coloration reaction is difficult to control. Consequently, the coloration density upon forming an image might be fluctuated.

The structure of the toner in the invention will be described in more detail for the case where the toner contains the photo-curable composition and microcapsules dispersed in the photo-curable composition.

In this case, the toner may have only one coloring part containing the photo-curable composition and the microcapsules dispersed in the photo-curable composition, and may also have two or more coloring parts. The term “coloring part” herein means a continuous region capable of being colored in one particular color upon application of external stimulation.

In the case where two or more coloring parts are contained in the toner, only one kind of coloring parts capable of being colored in the same color may be contained in the toner, and two or more kinds of coloring parts capable of being colored in different colors, respectively, may be contained in the toner. In the former case, the number of color that one toner particle forms is limited to one, but in the latter case, the number of colors that one toner particle forms can be two or more.

Examples of the combination of two or more kinds of coloring parts capable of being colored in different colors, respectively, include a combination containing a yellow coloring part capable of being colored in yellow color, a magenta coloring part capable of being colored in magenta color, and a cyan coloring part capable of being colored in cyan color.

In this case, for example, in the case where one of the coloring parts is colored by application of external stimulation, the toner is colored in one of yellow, magenta and cyan colors, and in the case where two of the coloring parts are colored, the toner is colored in colors obtained by combining these colors, whereby various colors can be expressed only by one kind of toner particles.

In the case where two or more coloring parts capable of being colored in different colors, respectively, are contained in the toner, the colors formed can be controlled not only by changing the kinds and combinations of the first components and the second components contained in the respective coloring parts, but also by changing the wavelength of light used for curing the photo-curable compositions contained in the respective coloring parts.

In the latter case, the wavelengths of light necessary for curing the photo-curable compositions contained in the respective coloring parts are different from each other, and therefore, plural kinds of light applying color forming information having different wavelengths may be used as control stimulation corresponding to the kinds of the coloring parts. In order to change the wavelengths of light necessary for curing the photo-curable compositions contained in the coloring parts, photopolymerization initiators sensitive to light having different wavelengths may be contained in the photo-curable compositions in the respective coloring parts.

For example, in the case where the toner contains three kinds of coloring parts capable of being colored in yellow, magenta and cyan, respectively, materials that are cured by responding to light having wavelengths of 405 nm, 532 nm and 657 nm, respectively, may be used as the photo-curable compositions contained in the respective coloring parts, whereby the toner can be colored in a desired color by using properly light applying color forming information having these three different wavelengths (light having a particular wavelength) corresponding to the coloring parts.

The wavelength of the light applying coloring information may be selected from the wavelength range of visible light, and may also be selected from the wavelength range of ultraviolet light. By using a shorter wavelength, a beam diameter can be reduced to attain a high resolution. Examples of a light source for the wavelength include a wavelength conversion solid SHG laser (the basic wavelength is converted to 1/2) and a gas laser.

The wavelength of the light applying coloring information may also be selected from the wavelength range of infrared light, whereby the cost of the illumination device can be reduced, and a high power output can be easily obtained, as having been known in the art.

The toner used in the invention may contain a mother material containing as a major component a binder resin similar to those used in a conventional toner using a colorant, such as a pigment. In this case, two or more of the coloring parts may be are dispersed in the mother material as capsules in a particle form. (Hereinafter, one coloring part in a capsule form may be referred to as a photosensitive and heat-sensitive capsule in some cases.) The mother material may further contain a releasing agent and various additives, as similar to the conventional toner using a colorant, such as a pigment.

The photosensitive and heat-sensitive capsule has a core containing the microcapsules and the photo-curable composition, and an outer shell covering the core, and the outer shell is not particularly limited as far as it can stably retain the microcapsules and the photo-curable composition inside the photosensitive and heat-sensitive capsule to prevent them from being leaked outside the photosensitive and heat-sensitive capsule during the production process of the toner described later and storage of the toner.

In the invention, the outer shell may contain as a major component a water insoluble material, such as a binder resin containing a water insoluble resin and a releasing agent, and a water insoluble resin, such as a styrene-acrylate copolymer and a polyester resin, may be used, whereby the second component can be prevented from flowing to the matrix outside the photosensitive and heat-sensitive capsule through the outer shell, and another kind of the second component contained in another photosensitive and heat-sensitive capsule capable of being colored in another color can be prevented from flowing into the photosensitive and heat-sensitive capsule through the outer shell, during the production process of the toner described later.

The toner used in the invention may have not only the aforementioned structure where the photosensitive and heat-sensitive capsules (coloring parts) are dispersed in the mother material (hereinafter, referred to as a coloring part dispersed structure in some case), but also a structure where two or more coloring parts are formed into layers (hereinafter, one coloring part formed into a layer may be referred to as a photosensitive and heat-sensitive layer in some cases).

Exemplary embodiments of the structure where two or more coloring parts are formed into layers include (1) an embodiment containing a photosensitive and heat-sensitive layer forming a core layer, and one or more photosensitive and heat-sensitive layers accumulated sequentially on the core layer so as to cover the core layer (hereinafter, referred to as a concentric structure in some cases), (2) an embodiment where a cross section of the toner obtained by cutting in a prescribed direction shows two or more photosensitive and heat-sensitive layers accumulated in a stripe shape (hereinafter, referred to as a stripe structure in some cases), and (3) an embodiment where a cross section of the toner obtained by cutting in a prescribed direction is divided into flabellate areas with the center of the toner as the base point, each of which contains the photosensitive and heat-sensitive layer (hereinafter, referred to as a flabellate structure in some cases).

In all the concentric structure, the stripe structure and the flabellate structure, an intermediate layer containing the materials constituting the outer shells of the photosensitive and heat-sensitive capsules may be formed between the two photosensitive and heat-sensitive layers adjacent to each other. The intermediate layer may contain a releasing agent and various additives, as similar to the conventional toner using a colorant, such as a pigment. The toners of the three structures may have on the outermost surface thereof a covering layer containing a binder resin.

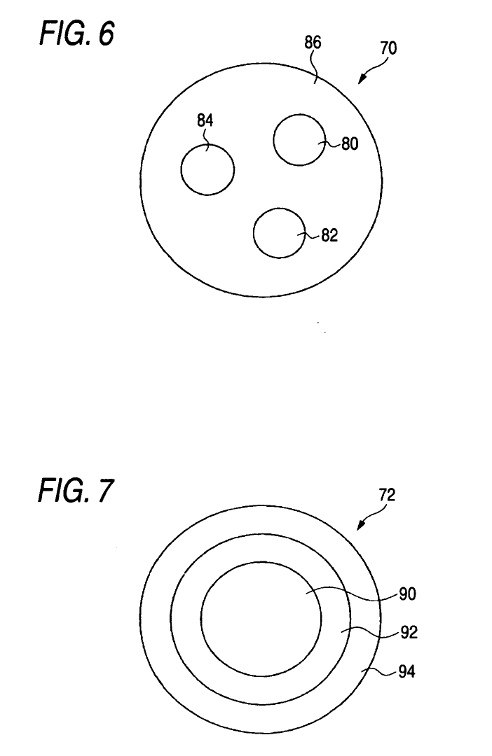

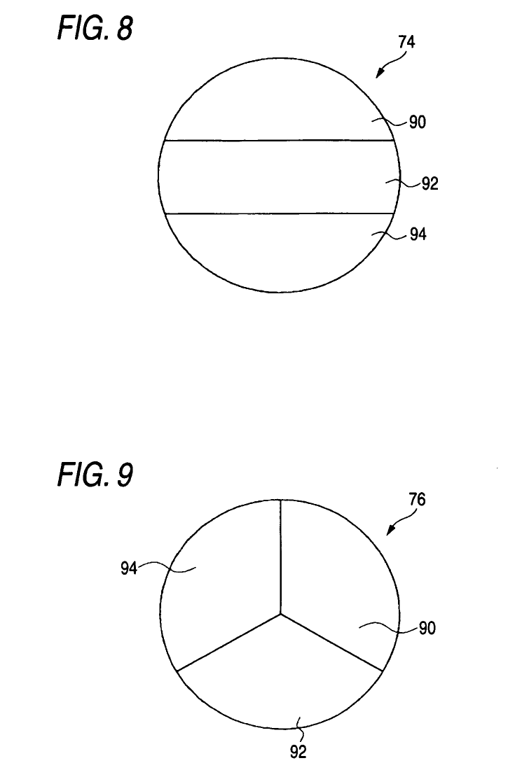

FIG. 6 is a schematic cross sectional view showing an exemplary embodiment of the toner of the invention containing a mother material and a coloring parts dispersed in the mother material, FIG. 7 is a schematic cross sectional view showing an exemplary embodiment of the toner of the invention having the concentric structure, FIG. 8 is a schematic cross sectional view showing an exemplary embodiment of the toner of the invention having the stripe structure, and FIG. 9 is a schematic cross sectional view showing an exemplary embodiment of the toner of the invention having the flabellate structure.

In FIGS. 6 to 9, numerals 70, 72, 74 and 76 each denotes a toner, 80 denotes a first coloring part, 82 denotes a second coloring part, 84 denotes a third coloring part, 86 denotes a mother material, 90 denotes a first photosensitive and heat-sensitive layer, 92 denotes a second photosensitive and heat-sensitive layer, and 94 denotes a third photosensitive and heat-sensitive layer. FIGS. 6 to 9 show only the important parts of the toners, and the intermediate layer provided between the photosensitive and heat-sensitive layers adjacent to each other, from which the covering layer provided on the outermost surface of the toner are omitted.

In the toner 70 shown in FIG. 6, three kinds of coloring parts 80, 82 and 84 are dispersed in a mother material 86 and are capable of being colored in yellow, magenta and cyan, respectively.

The toner 72 shown in FIG. 7 has a first photosensitive and heat-sensitive layer 90 constituting a core layer, and a second photosensitive and heat-sensitive layer 92 and a third photosensitive and heat-sensitive layer 94 accumulated sequentially on the first photosensitive and heat-sensitive layer 90 constituting the core layer. The toner 74 shown in FIG. 8 has a second photosensitive and heat-sensitive layer 92 in a stripe shape, and a first photosensitive and heat-sensitive layer 90 and a third photosensitive and heat-sensitive layer 94 in a stripe shape disposed on both sides of the second photosensitive and heat-sensitive layer 92. The toner 76 shown in FIG. 9 has three flabellate areas divided equally with the center part of the toner as the base point, and the three areas contain three photosensitive and heat-sensitive layers 90, 92 and 94, respectively. In the toners 72, 74 and 76 shown in FIGS. 7 to 9, the three photosensitive and heat-sensitive layers 90, 92 and 94 are capable of being colored, for example, in yellow, magenta and cyan, respectively.

The toner having the coloring part dispersed structure or the concentric structure can be produced, for example, by an aggregation and integration method described later, and the toner having the concentric structure, the stripe structure or the flabellate structure can be produced, for example, by a wet production method using a microreactor.

The toner in the invention may have only one coloring part, as well as two or more coloring parts such as the coloring part dispersed structure, the concentric structure, the stripe structure and the flabellate structure shown in FIGS. 6 to 9. In this case, the one coloring part itself may be used as the toner.

### Constitutional Materials of Light Non-Coloring Type Toner

The constitutional materials in the case where the toner in the invention is the light non-coloring type toner, and materials and methods used upon preparing the constitutional materials will be described in more detail below.

In this case, the toner contains at least the first component, the second component, the microcapsules containing the first component, and the photo-curable composition containing the second component, and the photo-curable composition may contain a photopolymerization initiator and may also contain various kinds of assistants. The first component may be contained in the microcapsules (core) in a solid state or along with a solvent.

In the light non-coloring type toner, an electron donative colorless dye or a diazonium salt compound may be used as the first component, and an electron acceptive compound having a photopolymerizable group or a coupler compound having a photopolymerizable group may be used as the second component.

In addition to the aforementioned compounds, various materials as similar to materials constituting the conventional toner using a colorant, such as a binder resin, a releasing agent, an internal additive and an external additive, may be appropriately utilized. The materials will be described in more detail below.

### First Component and Second Component

Examples of the combination of the first component and the second component include the following combinations (a) to (r), in each of which the former is the first component, and the latter is the second component.

(a) Combination of an electron donative colorless dye and an electron acceptive compound
(b) Combination of a diazonium salt compound and a coupling component (which is hereinafter referred to as a coupler compound in some cases)
(c) Combination of an organic metallic salt, such as silver behenate and silver stearate, and a reducing agent, such as protocatechinic acid, spiroindane and hydroquinone
(d) Combination of a long chain fatty acid iron salt, such as ferric stearate and ferric myristate, and a phenol compound, such as tannic acid, gallic acid and ammonium salicylate
(e) Combination of an organic heavy metallic salt, such as a nickel salt, a cobalt salt, a lead salt, a copper salt, an iron salt, a mercury salt and a silver salt of acetic acid, stearic acid and palmitic acid, and a sulfide of an alkali metal or an alkaline earth metal, such as calcium sulfide, strontium sulfide and potassium sulfide, or combination of the organic heavy metallic salt and an organic chelating agent, such as s-diphenylcarbazide and diphenylcarbazone
(f) Combination of a heavy metallic sulfate, such as sulfates of silver, lead, mercury and sodium, and a sulfur compound, such as sodium tetrathionate, sodium thiosulfate and thiourea
(g) Combination of a fatty acid ferric salt, such as ferric stearate, and an aromatic polyhydroxy compound, such as 3,4-hydroxytetraphenylmethane
(h) Combination of an organic metallic salt, such as silver oxalate and mercury oxalate, and an organic polyhydroxy compound, such as polyhydroxy alcohol, glycerin and glycol
(i) Combination of a fatty acid ferric salt, such as ferric pelargonate and ferric laurate, and thiocetylcarbamide or an isothiocetylcarbamide derivative
(j) Combination of an organic lead salt, such as lead caproate, lead pelargonate and lead behenate, and a thiourea derivative, such as ethylene thiourea and N-dodecylthiourea
(k) Combination of a higher fatty acid heavy metallic salt, such as ferric stearate and copper stearate, and zinc dialkyldithiocarbamate
(l) Combination forming an oxazodine dye, such as combination of resorcin and a nitroso compound
(m) Combination of a formazan compound and a reducing agent and/or a metallic salt
(n) Combination of a protected dye (or leuco dye) precursor and a deprotecting agent
(o) Combination of an oxidized coloring agent and an oxidizing agent
(p) Combination of a phthalonitrile compound and a diiminoisoindoline compound (combination forming phthalocyanine)
(q) Combination of an isocyanate compound and a diiminoisoindoline compound (combination forming a colored pigment)
(r) Combination of a pigment precursor and an acid or a base (combination forming a pigment)

The first component used in the invention may be a substantially colorless electron donating colorless dye or a diazonium salt compound among the aforementioned examples of the first component.

The electron donative colorless dye may be a known compound as far as it exerts coloration through reaction with the second component. Specific examples thereof include a phthalide compound, a fluoran compound, a phenothiazine compound, an indolylphthalide compound, a leucoauramine compound, a rhodamine lactam compound, a triphenylmethane compound, a triazene compound, a spiropyran compound, a pyridine compound, a pyrazine compound and a fluorene compound. The electron donative colorless dye that can be used in the invention is not limited to these compounds.

In the case where a full color image is formed in the invention, electron donative colorless dyes for coloring in cyan, magenta and yellow may be used.

Examples of the cyan, magenta and yellow coloring dyes include dyes disclosed in U.S. Pat. No. 4,800,149. Examples of the yellow coloring electron donative colorless dye include dyes disclosed in U.S. Pat. No. 4,800,148, and examples of the cyan coloring electron donative colorless dye include dyes disclosed in JP-A-63-53542.

The using amount of the electron donative colorless dye is preferably from 0.01 to 3 g/m², and more preferably from 0.1 to 1 g/m², in the photosensitive and heat-sensitive capsules (or the photosensitive and heat-sensitive layer) in the case where the toner has the structures exemplified in FIGS. 6 to 9. In the case where the using amount is less than 0.01 g/m², a sufficient coloration density might not be obtained, and in the case where it exceeds 3 g/m², the formation of the photosensitive and heat-sensitive capsules (or the photosensitive and heat-sensitive layer) might become difficult. The same using amount of the electron donative colorless dye can be applied to the case where the toner in the invention has a structure containing only one coloring part.

Examples of the diazonium salt compound include the compound represented by the following formula (I):

Ar−N₂+X. (I)

wherein Ar represents an aromatic ring group, and X. represents an acid anion.

The diazonium salt compound is such a compound that is colored through coupling reaction with a coupler under heating, and is decomposed with light. The maximum absorption wavelength can be controlled with the position and kind of a substituent on the Ar ring.

The maximum absorption wavelength λₘₐₓ of the diazonium salt compound used in the invention is preferably 450 nm or less, and more preferably from 290 to 440 nm, from the standpoint of effect. The diazonium salt compound used in the invention may be such a diazonium salt compound that contains 12 or more carbon atoms, and has a solubility in water of 1% by mass or less and a solubility in ethyl acetate of 5% by mass or more.

The diazonium salt compound may be used solely or in combination of two or more kinds thereof for such a purpose as control of the hue.

The using amount of the diazonium salt compound is preferably from 0.01 to 3 g/m², and more preferably from 0.02 to 1.0 g/m², in the photosensitive and heat-sensitive capsules (or the photosensitive and heat-sensitive layer) in the case where the toner has the structures exemplified in FIGS. 6 to 9. In the case where the using amount is less than 0.01 g/m², sufficient coloration property might not be obtained, and in the case where it exceeds 3 g/m², the sensitivity might be lowered, and the period of time for irradiating with light after fixing, which is carried out depending on necessity, might be prolonged. The same using amount of the diazonium salt compound can be applied to the case where the toner in the invention has a structure containing only one coloring part.

The second component used in the invention is such a substantially colorless compound having, in the same molecule, a photopolymerizable group and a part capable of being colored through reaction with the first component, and any of an electron acceptive compound having a photopolymerizable group and a coupler compound having a photopolymerizable group may be used as the second component as far as they have the two functions, i.e., they are colored through reaction with the first component and are polymerized and cured in response to light.

As the electron acceptive compound having a photopolymerizable group, i.e., the compound having, in the same molecule, an electron acceptive group and a photopolymerizable group, any compound can be used that has a photopolymerizable group, is colored through reaction with the electron donative colorless dye as the first component, and is cured through photopolymerization.

Examples of the electron acceptive compound include compounds that can be synthesized with reference to 3-halo-4-hydroxybenzoic acid disclosed in JP-A-4-226455, a methacryloxyethyl ester and acryloxyethyl ester of benzoic acid having a hydroxyl group disclosed in JP-A-63-173682, an ester of benzoic acid having a hydroxyl group and hydroxymethylstyrene disclosed in JP-A-59-83693, JP-A-60-141587 and JP-A-62-99190, hydroxystyrene disclosed in European Patent No. 29,323, an N-vinylimidazole complex of zinc halide disclosed in JP-A-62-167077 and JP-A-62-16708, and an electron acceptive compound disclosed in JP-A-63-317558.

Among the compounds having, in the same molecule, an electron acceptive group and a polymerizable group, 3-halo-4-hydroxybenzoic acid represented by the following general formula is preferred:

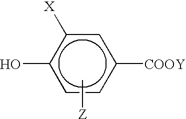

wherein X represents a halogen atom, and preferably a chlorine atom; Y represents a monovalent group having an ethylenic polymerizable group, preferably an aralkyl group, an acryloyloxyalkyl group or a methacryloyloxyalkyl group having a vinyl group, and more preferably an acryloyloxyalkyl group having from 5 to 11 carbon atoms or a methacryloyloxyalkyl group having from 6 to 12 carbon atoms; and Z represents a hydrogen atom, an alkyl group or an alkoxy group.

The electron acceptive compound having a photopolymerizable group may be used in combination with the electron donative colorless dye. In this case, the using amount of the electron acceptive compound is preferably from 0.5 to 20 parts by mass, and more preferably from 3 to 10 parts by mass, per 1 part by mass of the electron donative colorless dye used. In the case where the using amount is less than 0.5 part by mass, a sufficient coloration density might not be obtained, and in the case where it exceeds 20 parts by mass, the sensitivity might be lowered, and the formation of the photosensitive and heat-sensitive capsules (or the photosensitive and heat-sensitive layer) might become difficult.

As the coupler compound having a photopolymerizable group, any compound can be used that has a photopolymerizable group, is colored through reaction with a diazonium salt compound as the first component, and is cured through photopolymerization. The coupler compound forms a dye through coupling with a diazo compound in a basic atmosphere and/or a neutral atmosphere, and may be used in combination of plural kinds thereof for such a purpose as control of the hue.

The coupler compound may be used in combination with the diazonium salt compound. The using amount of the coupler compound is preferably from 0.02 to 5 g/m², and more preferably from 0.1 to 4 g/m², in the photosensitive and heat-sensitive capsules (or the photosensitive and heat-sensitive layer) in the case where the toner has the structures exemplified in FIGS. 6 to 9. In the case where the using amount is less than 0.02 g/m², the coloration property might be inferior, and in the case where it exceeds 5 g/m², the formation of the photosensitive and heat-sensitive capsules (or the photosensitive and heat-sensitive layer) might become difficult. The same using amount of the coupler compound can be applied to the case where the toner in the invention has a structure containing only one coloring part.

The using amount of the coupler compound is preferably from 0.5 to 20 parts by mass, and more preferably from 1 to 10 parts by mass, per 1 part by mass of the diazonium salt compound used. In the case where the using amount is less than 0.5 part by mass, a sufficient coloration density might not be obtained, and in the case where it exceeds 20 parts by mass, the formation of the photosensitive and heat-sensitive capsules (or the photosensitive and heat-sensitive layer) might become difficult.

The coupler compound may be used as a solid dispersion obtained by dispersing with a sand mill or the like after adding a water soluble polymer along with other components, and may also be used as emulsion obtained by emulsifying with a suitable emulsifier. The methods of obtaining solid dispersion and emulsion are not particularly limited, and may be appropriately selected from known methods. The methods are described in detail in JP-A-59-190886, JP-A-2-141279 and JP-A-7-17145.

In order to accelerate the coupling reaction, an organic base may be used, such as a tertiary amine compound, a piperidine compound, a piperazine compound, an amidine compound, a formamidine compound, a pyridine compound, a guanidine compound and a morpholine compound.

The organic base are described in JP-A-57-123086, JP-A-60-49991, JP-A-60-94381, JP-A-9-71048, JP-A-9-77729, and JP-A-9-77737.

The using amount of the organic base is not particularly limited and is preferably from 1 to 30 mol per 1 mol of the diazonium salt. The organic base may be used solely or in combination of plural kinds thereof.

In order to accelerate the coloration reaction, a coloration assistant may be added. Examples of the coloration assistant include a phenol derivative, a naphthol derivative, an alkoxy-substituted benzene compound, an alkoxy-substituted naphthalene compound, a hydroxyl compound, a carboxylic amide compound and a sulfonamide compound. These compounds have such a function that the melting point of the coupler compound or the basic substance is decreased, or the thermal permeability of the microcapsule wall (outer shell) is increased, whereby a high coloration density might be obtained.

### Photopolymerization Initiator

The photopolymerization initiator used in the invention will be described. The photopolymerization initiator generates a radical upon irradiation with light applying color forming information to invoke and accelerate polymerization reaction in the photo-curable composition. The photo-curable composition is cured through the polymerization reaction.

The photopolymerization initiator may be selected from known compounds, and may preferably contain a spectral sensitizing compound having a maximum absorption wavelength in a range of from 300 to 1,000 nm and a compound undergoing mutual reaction with the spectral sensitizing compound.

In the case where the compound undergoing mutual reaction with the spectral sensitizing compound is such a compound that has both structures, i.e., a dye part having a maximum absorption wavelength in a range of from 300 to 1,000 nm and a borate part, the spectral sensitizing dye may not be used.

Examples of the known photopolymerization initiator include those disclosed in U.S. Pat. No. 4,950,581 (column 20, line 35 to column 21, line 35). Examples thereof also include a triazine compound, such as triazine and trihalomethyltriazine, e.g., 2,4-bis(trichloromethyl)-6-(4-stilphenyl)-s-triazine disclosed in EP-A-137,452, DE-A-2,718,254, DE-A-2,243,621 and U.S. Pat. No. 4,950,581 (column 14, line 60 to column 18, line 44).

In the case where the photopolymerization initiator is used as a hybrid system, examples thereof also include a free radical curing agent and a cationic photopolymerization initiator. Examples of the cationic photopolymerization initiator include a peroxide compound, such as benzoyl peroxide and a peroxide compound disclosed in U.S. Pat. No. 4,950,581 (column 19, lines 17 to 25), an aromatic sulfonium or iodonium salt disclosed in U.S. Pat. No. 4,950,581 (column 18, line 60 to column 19, line 10), and a cyclopentadienyl arene iron(II) complex salt, such as (η⁶-isopropylbenzene)-(η⁵-cyclopentadienyl)-iron(II) hexafluorophosphate.

Examples of the dye/boron compound include those disclosed in JP-A-62-143044, JP-A-1-138204, JP-T-6-505287 and JP-A-4-261406.

As the spectral sensitizing compound having a maximum absorption wavelength in a range of from 300 to 1,000 nm, such a spectral sensitizing dye having a maximum absorption wavelength in the range may be used. A dye may be arbitrarily selected from spectral sensitizing dyes having a maximum absorption wavelength in the range, so as to control the sensitive wavelength for conforming with the light source used for radiating the light applying color forming information, whereby a high sensitivity can be obtained.

The spectral sensitizing dye may be appropriately selected from known compounds, and examples thereof include those disclosed in Research Disclosure, vol. 200, item 20036, December of 1980, and “Zokanzai” (Sensitizers), p. 160-163, Kodansha, edited by K. Tokumaru and S. Ogawara (1987).

Specific examples thereof include a 3-ketocoumarin compound disclosed in JP-A-58-15603, a thiopyrylium salt disclosed in JP-A-58-40302, a naphthothiazole merocyanine compound disclosed in JP-B-59-28328 and JP-B-60-53300, and a merocyanine compound disclosed in JP-B-61-9621, JP-B-62-3842, JP-A-59-89303 and JP-A-60-60104.

Examples thereof also include dyes disclosed in “Kinousei Shikiso no Kagaku” (Chemistry of Functional Dyes), p. 393-416, published by CMC Press (1981) and “Shikizai” (Color Materials), vol. 60(4), p. 212-224 (1987), and specific examples thereof include a cationic methine dye, a cationic carbonium dye, a cationic quinonimine dye, a cationic indoline dye and a cationic styryl dye.

The spectral sensitizing dye include a keto dye, such as a coumarin dye (including ketocoumarin and sulfonocoumarine dyes), a merostyryl dye, an oxonol dye and a hemioxonol dye; a non-keto dye, such as a non-ketopolymethine dye, a triarylmethane dye, a xanthene dye, an anthracene dye, a rhodamine dye, an acridine dye, an aniline dye and an azo dye; a non-ketopolymethine dye, such as an azomethine dye, a cyanine dye, a carbocyanine dye, a dicarbocyanine dye, a tricarbocyanine dye, a hemicyanine dye and a styryl dye; and a quinonimine dye, such as an azine dye, an oxazine dye, a thiazine dye, a quinoline dye and a thiazole dye.

By using the spectral sensitizing dye appropriately, the spectral sensitivity of the photopolymerization initiator used in the toner can be obtained in a range of from ultraviolet region to infrared region. The spectral sensitizing dyes may be used solely or in combination of plural kinds thereof.

The using amount of the spectral sensitizing dye is preferably from 0.1 to 5% by mass, and more preferably from 0.5 to 2% by mass, based on the total weight of the materials constituting the photosensitive and heat-sensitive capsules (or the photosensitive and heat-sensitive layer) in the case where the toner in the invention has the structures exemplified in FIGS. 6 to 9. The same using amount can be applied to the case where the toner in the invention has a structure containing only one coloring part.

The compound undergoing mutual reaction with the spectral sensitizing compound may be one or plural compounds appropriately selected from known compounds capable of initiating photopolymerization reaction with the photopolymerizable group in the second component.

In the case where the compound is used in combination with the spectral sensitizing compound, it sensitively responds to irradiated light within the spectral absorption wavelength range thereof to generate radicals with high efficiency, whereby a high sensitivity can be obtained, and the formation of radicals can be controlled by using an arbitrary light source in a range of from ultraviolet region to infrared region.

The compound undergoing mutual reaction with the spectral sensitizing compound may be an organic borate salt compound, a benzoin ether compound, an S-triazine derivative having a trihalogen-substituted methyl group, an organic peroxide compound and an azinium salt compound, and an organic borate compound is preferred. In the case where the compound undergoing mutual reaction with the spectral sensitizing compound is used in combination with the spectral sensitizing compound, radicals can be generated efficiently and locally within the exposed area, whereby a high sensitivity can be obtained.

Examples of the organic borate salt compound include an organic borate compound disclosed in JP-A-62-143044, JP-A-9-188685, JP-A-9-188686 and JP-A-9-188710 (hereinafter, referred to as a borate compound I in some cases), and a spectral sensitizing dye series borate compound derived from a cationic dye disclosed in “Kinousei Shikiso no Kagaku” (Chemistry of Functional Dyes), p. 393-416, published by CMC Press (1981) and “Shikizai” (Color Materials), vol. 60(4), p. 212-224 (1987) (hereinafter, referred to as a borate compound II in some cases).

The borate compound II contains in the structure thereof both a dye part and a borate part, and upon exposure, the borate compound II exerts the three functions, i.e., the borate compound II efficiently absorbs the energy from the light source through the light absorbing function of the dye part, accelerates polymerization reaction through the radical releasing function of the borate part, and simultaneously decoloring the spectral sensitizing compound present therewith.

Specifically, any cationic dye can be used that has a maximum absorption wavelength in a wavelength range of 300 nm or more, and preferably in a wavelength range of from 400 to 1,100 nm. Examples thereof include such a cationic dye as a methine dye, a polymethine dye, a triarylmethane dye, an indoline dye, an azine dye, a xanthene dye, a cyanine dye, a hemicyanine dye, a rhodamine dye, an azamethine dye, an oxazine dye and an acridine dye, and preferably such a cationic dye as a cyanine dye, a hemicyanine dye, a rhodamine dye and an azamethine dye.

The borate compound II derived from the organic cationic dye can be obtained by using the organic cationic dye and an organic boron compound anion according to a method disclosed in European Patent No. 223,587A1.

While the borate compound II is a multifunctional compound as having been described, the photopolymerization initiator in the invention may be constituted by combining the spectral sensitizing compound and the compound undergoing mutual reaction with the spectral sensitizing compound from the standpoint of obtaining a high sensitivity and a sufficient decoloration property. In this case, the photopolymerization initiator may be a photopolymerization initiator (1) obtained by combining the spectral sensitizing compound and the borate compound I, and a photopolymerization initiator (2) obtained by combining the borate compound I and the borate compound II.

The using ratio between the spectral sensitizing dye and the organic borate compound present in the photopolymerization initiator is considerably useful from the standpoint of obtaining a high sensitivity and sufficient decoloration property (deactivation, decomposition and the like of unreacted substances) upon irradiation of light in the light radiating step, which is effected depending on necessity after the coloration by the heat treatment upon fixing for forming an image.

In the photopolymerization initiator (1), the ratio of the spectral sensitizing compound to the borate compound I required for photopolymerization reaction (=1/1 by mol) may be assured, and the borate compound I may be added in such an amount that is required for sufficiently decoloring the spectral sensitizing compound remaining in the toner, from the standpoint of obtaining a high sensitivity and sufficient decoloration capability.

Accordingly, the ratio of the spectral sensitizing compound to the borate compound I (spectral sensitizing compound/borate compound I) is preferably in a range of from 1/1 to 1/50, more preferably from 1/1.2 to 1/30, and most preferably from 1/1.2 to 1/20. In the case where the ratio is less than 1/1, the polymerization reactivity and the decoloration capability might not be sufficiently obtained, and in the case where the ratio exceeds 1/50, the formation of the photosensitive and heat-sensitive capsules (or the photosensitive and heat-sensitive layer) might become difficult.

In the photopolymerization initiator (2), the borate compound I and the borate compound II may be used in such a combination that the amount of the borate part is an equimolar ratio or more of the amount of the dye part, from the standpoint of obtaining a high sensitivity and sufficient decoloration capability. The ratio of the borate compound I to the borate compound II (borate compound I/borate compound II) is preferably in a range of from 1/1 to 50/1, more preferably from 1.2/1 to 30/1, and most preferably from 1.2/1 to 20/1. In the case where the ratio is less than 1/1, only a small amount of radicals might be formed to fail to obtain sufficiently polymerization reactivity and decoloration capability, and in the case where the ratio exceeds 50/1, a sufficient sensitivity might not be obtained.

The total amount of the spectral sensitizing compound and the organic borate compound in the photopolymerization initiator is preferably from 0.1 to 10% by mass, more preferably from 0.1 to 5% by mass, and most preferably from 0.1 to 1% by mass, based on the using amount of the compound having a photopolymerizable group (second component). In the case where the total amount is less than 0.1% by mass, the effect of the invention might not be obtained, and in the case where the total amount exceeds 10% by mass, the toner might be deteriorated in storage stability, and the formation of the photosensitive and heat-sensitive capsules (or the photosensitive and heat-sensitive layer) might become difficult.

### Assistants

In order to accelerate the polymerization reaction, the photo-curable composition may contain, as assistants, a reducing agent, such as an oxygen scavenger and a chain transfer agent of an active hydrogen donor, and other compounds capable of accelerating the polymerization through chain transfer.

Examples of the oxygen scavenger include a phosphine compound, a phosphonate compound, a phosphite compound, an argentous salt and other compounds capable of being easily oxidized with oxygen. Specific examples thereof include N-phenylglycine, trimethylbarbituric acid, N,N-dimethyl-2,6-diisopropylaniline and N,N,N-2,4,6-pentamethylaniline acid. Furthermore, a thiol compound, a thioketone compound, a trihalomethyl compound, a lophine dimer compound, an iodonium salt compound, a sulfonium salt compound, an azinium salt compound, an organic peroxide compound and an azide compound are useful as a polymerization accelerator.

### Microencapsulation

In the invention, the first component, such as the electron donative colorless dye and the diazonium salt compound, is used after encompassed in microcapsules.

The method of microencapsulation may be a known method. Examples thereof include a method using coacervation of a hydrophilic wall forming material disclosed in U.S. Pat. No. 2,800,457 and U.S. Pat. No. 2,800,458, an interface polymerization method disclosed in U.S. Pat. No. 3,287,154, British Patent No. 990,443, JP-B-38-19574, JP-B-42-446 and JP-B-42-771, a method using deposition of a polymer disclosed in U.S. Pat. No. 3,418,250 and U.S. Pat. No. 3,660,304, a method using an isocyanate polyol wall material disclosed in U.S. Pat. No. 3,796,669, a method using an isocyanate wall material disclosed in U.S. Pat. No. 3,914,511, a method using a urea-formaldehyde or urea-formaldehyde-resorcinol wall forming material disclosed in U.S. Pat. No. 4,001,140, U.S. Pat. No. 4,087,376 and U.S. Pat. No. 4,089,802, a method using a wall forming material, such as a melamine-formaldehyde resin and a hydroxypropyl cellulose, disclosed in U.S. Pat. No. 4,025,455, an in situ method through polymerization of a monomer disclosed in JP-B-36-9168 and JP-A-51-9079, an electrolytic dispersing and cooling method disclosed in British Patent No. 952,807 and British Patent No. 965,074, a spray drying method disclosed in U.S. Pat. No. 3,111,407 and British Patent No. 930,422, and methods disclosed in JP-B-7-73069, JP-A-4-101855 and JP-A-9-263057.

The method of microencapsulation is not limited to these methods, and in the invention, an interface polymerization method may be particularly employed that an oily phase obtained by dissolving or dispersing the first component in a hydrophobic organic solvent to be a core of capsules is mixed with an aqueous phase having a water soluble polymer dissolved therein, and the mixture is emulsified with such an apparatus as a homogenizer and then heated, whereby polymer forming reaction is effected at an interface of the oil droplets to form a microcapsule wall of a polymer. The interface polymerization method can form capsules having a uniform particle diameter in a short period of time to provide a toner excellent in storage stability before use.

The microcapsules used in the invention may utilize such a phenomenon that substances inside and outside the microcapsule are inhibited from being contact with each other by the substance isolation function of the microcapsule wall (outer shell), and only in the case where at least one of heat and pressure is applied thereto at a prescribed value or higher, the substances inside and outside the microcapsule are made in contact with each other. The phenomenon can be freely controlled as a change in property of the capsules by appropriately selecting the material of the microcapsule wall, the substance contained in the core of the microcapsules and an additive added thereto.

The material of the microcapsule wall capable of being used in the invention is added to at least one of the interior of the oily droplets and the exterior of the oily droplets. Examples of the material of the microcapsule wall include polyurethane, polyurea, polyamide, polyester, polycarbonate, a urea-formaldehyde resin, a melamine resin, polystyrene, a styrene-methacrylate copolymer and a styrene-acrylate copolymer. Among these, polyurethane, polyurea, polyamide, polyester and polycarbonate are preferred, and polyurethane and polyurea are more preferred. The polymer substances may be used in combination of plural kinds thereof.

All the components including the first component may be used as emulsion dispersion, which is obtained in such a manner that the components are dissolved in a water sparingly soluble or water insoluble high boiling point organic solvent, and the resulting solution is mixed with a polymer aqueous solution (aqueous phase) containing at least one of a surfactant and a water soluble polymer as a protective colloid, followed by emulsifying with a homogenizer or the like, while they may be used as a solid dispersion obtained by dispersing along with, for example, a water soluble polymer a sensitizer and a coloration assistant, by a method, such as a sand mill. In the case of the emulsion dispersion, a low boiling point solvent may be added as a dissolution assistant depending on necessity. All the components including the first component may be separately emulsified, or may be mixed with each other and then dissolved in at least one of the high boiling point solvent and the low boiling point solvent, followed by being emulsified. The particle diameter of the emulsion obtained by emulsion dispersion is preferably 1 μm or less.

After forming emulsion, the emulsion is heated to a temperature of from 30 to 70° C. for accelerating the reaction of forming the microcapsule wall. In order to prevent the microcapsules from being aggregated during the reaction, the reaction system may be added with water to lower the collision probability of the microcapsules, or may be sufficiently agitated. A dispersion for preventing aggregation may be separately added to the reaction system during the reaction. The end point of the reaction of forming the microcapsule wall can be determined by observing generation of carbon dioxide gas associated with progress of the polymerization reaction, and the time when the generation of carbon dioxide is terminated can be designated as the end point of the reaction. In general, microcapsules having the first component encapsulated therein can be obtained through reaction for several hours.

The volume average particle diameter of the microcapsules is preferably controlled to a range of from 0.1 to 3.0 μm, and more preferably a range of from 0.3 to 1.0 μm.

The toner having the structure disclosed in FIGS. 6 to 9 may contain a binder in the photosensitive and heat-sensitive capsules (or photosensitive and heat-sensitive layer), and this is also the case of a toner having only one coloring part.

Examples of the binder include the same materials as the binders used for emulsification of the photo-curable composition, the water soluble polymers used for microencapsulating the first component, a solvent soluble polymer, such as polystyrene, polyvinylformal, polyvinyl butyral, an acrylate resin, e.g., polymethyl acrylate, polybutyl acrylate, polymethyl methacryalte, polybutyl methacrylate and copolymers thereof, a phenol resin, a styrene-butadiene resin, ethyl cellulose, an epoxy resin and a urethane resin, and polymer latices of these polymers. Among these, gelatin and polyvinyl alcohol are preferably used. A binder resin described later may be also be used as the binder.

Furthermore, such an additive as a dye, an ultraviolet light absorbent, a plasticizer, a fluorescent whitening agent, a curing agent and an antistatic agent, may be used depending on necessity. Specific examples of the additive are disclosed in Research Disclosure, vol. 176, item 17643, December of 1978, and Research Disclosure, vol. 187, item 18716, November of 1979.

### Curing Agent

In the toner having the structure disclosed in FIGS. 6 to 9, a curing agent may be used in combination in such a layer as the photosensitive and heat-sensitive capsules (or photosensitive and heat-sensitive layer) and the intermediate layer.

Examples of the curing agent include a gelatin hardener used upon production of a photographic photosensitive material, and specific examples thereof include an aldehyde compound, such as formaldehyde and glutaraldehyde, a reactive halogen compound disclosed in U.S. Pat. No. 3,635,718, a compound having a reactive ethylenic unsaturated group disclosed in U.S. Pat. No. 3,635,718, an aziridine compound disclosed in U.S. Pat. No. 3,017,280, an epoxy compound disclosed in U.S. Pat. No. 3,091,537, a halogenocarboxyaldehyde compound, such as mucochloric acid, a dioxane compound, such as dihydroxydioxane and dichlorodioxane, a vinyl sulfone compound disclosed in U.S. Pat. No. 3,642,486 and U.S. Pat. No. 3,687,707, a vinyl sulfone precursor compound disclosed in U.S. Pat. No. 3,841,872, and a keto vinyl compound disclosed in U.S. Pat. No. 3,640,720. Furthermore, chromium alum, zirconium sulfate, boric acid and the like may also be used as an inorganic curing agent.

### Binder Resin

In the toner of the invention, a binder resin having been used in conventional toners may be used. The binder resin may be used as a major component constituting the mother material and a material constituting the outer shell of the photosensitive and heat-sensitive capsules of the toner having the structure containing the photosensitive and heat-sensitive capsules dispersed in the mother particles as shown in FIG. 6, and may be used as a material constituting the covering layer provided on the outermost surface of the toner and the intermediate layer provided between the coloring parts adjacent to each other of the toner having the structure containing two or more coloring parts in a layer form, such as the concentric structure, the stripe structure and the flabellate structure, as shown in FIGS. 7 to 9.

The binder resin is not particularly limited, and known crystalline and amorphous resin materials may be used. In order to impart low temperature fixing property to the toner, a crystalline polyester resin having sharp melt property may be used.

The melting point of the crystalline resin is preferably from 50 to 110° C., and more preferably from 60 to 90° C. In the case where the melting point is less than 50° C., there might be a problem in storage stability of the toner, and storage stability of a toner image after fixing, and in the case where the melting point exceeds 110° C., fixing property might not be obtained at a sufficiently low temperature as compared to the conventional toner.

There are cases where a crystalline resin has plural melting peaks, and in the invention, the maximum peak is designated as a melting point.

As the amorphous polymer, known resin materials may be used, such as a styrene-acrylate resin and a polyester resin, and an amorphous polyester resin is preferably used. The amorphous polyester resin used in the invention may be obtained mainly by polycondensation of a polyhydric carboxylic acid and a polyhydric alcohol.

In the case where an amorphous polyester resin is used, a resin particle dispersion liquid can be easily obtained by effecting emulsion dispersion with adjustment of the acid value of the resin and the use of an ionic surfactant.

The amorphous polymer used in the toner preferably has a mass average molecular weight (Mw) of from 5,000 to 1,000,000, and more preferably from 7,000 to 500,000, a number average molecular weight (Mn) of from 2,000 to 10,000, and a molecular weight distribution Mw/Mn of from 1.5 to 100, and more preferably from 2 to 60, measured by a gel permeation chromatograph (GPC) method of a component soluble in tetrahydrofuran (THF).

The glass transition temperature of the amorphous polymer that can be used in the invention is preferably from 35 to 100° C., and more preferably from 50 to 80° C. from the standpoint of balance between the storage stability and the fixing property of the toner. In the case where the glass transition temperature is less than 35° C., there is such a tendency that the toner undergoes blocking (which is a phenomenon where the toner particles are aggregated to form clusters) during storage or in a developing device. In the case where the glass transition temperature exceeds 100° C., on the other hand, the fixing temperature of the toner might be too high.

The softening point of the amorphous polymer is preferably in a range of from 80 to 130° C., and more preferably a range of from 90 to 120° C. In the case where the softening point is less than 80° C., the stability of the toner and an image formed with the toner after fixing and during storage might be deteriorated. In the case where the softening point exceeds 130° C., the low temperature fixing property might be deteriorated.

The softening point of the amorphous polymer herein designates an intermediate temperature between the melt starting temperature and the melt completing temperature measured with a flow tester (CFT-500C, produced by Shimadzu Corp.) under conditions of preheating of 80° C. for 300 seconds, a plunger pressure of 0.980665 MPa, a die size of 1 mm in diameter×1 mm, and a temperature increasing rage of 3.0° C. per minute.

### Releasing Agent

The toner of the invention may contain a releasing agent. The releasing agent is used generally for improving the releasing property.

The releasing agent used in the toner is not particularly limited, and examples thereof include mineral or petroleum wax, such as montan wax, ozokerite, ceresin, paraffin wax, microcrystalline wax and Fischer-Tropsch wax, natural gas wax and a modified product thereof, low molecular weight polyolefin, such as polyethylene, polypropylene and polybutene, a silicone exhibiting a softening point by heating, a fatty acid amide, such as oleic amide, erucic amide, recinoleic amide and stearic amide, vegetable wax, such as carnauba wax, rice wax, candelilla wax, haze wax and jojoba oil, and animal wax, such as bees wax, and examples of the modification assistant component include a higher alcohol having from 10 to 18 carbon atoms and a mixture thereof, and a higher fatty acid monoglyceride having from 16 to 22 carbon atoms and a mixture thereof, which may be used in combination.

### Other Additives

The toner used in the invention may contain other components than those described hereinabove. The other components may not be particularly limited and can be appropriately selected depending on purposes. Examples thereof include inorganic fine particles, organic fine particles and a charge controlling agent, which are additives having been used in a conventional toner. The toner of the invention may not contain a colorant, such as a pigment, which has been used in the conventional toner, since the toner of the invention is colored by itself, but a small amount of a known colorant may be used depending on necessity for finely adjusting the color tone after coloration.

The charge controlling agent is used for further improving and stabilizing the charging property. Examples of the charge controlling agent include various charge controlling agents having been used, such as a quaternary ammonium salt compound, a nigrosine compound, a dye containing a complex of aluminum, iron or chromium, and a triphenylmethane pigment, and a material that is sparingly soluble in water may be used from the standpoint of control of the ion intensity affecting the stability of the aggregated particles formed in the solution in the case where the toner is produced by the aggregation and integration method described later, and reduction in pollution due to wastewater.

For the purposes of imparting flowability and improving the cleaning property, inorganic particles, such as silica, alumina, titania and calcium carbonate, and resin particles, such as a vinyl resin, polyester and silicone, may be added as a flowing assistant or a cleaning assistant to the toner surface in a dry state under application of shearing force, as similar to the ordinary toner.

### Constitutional Materials of Light Coloring Type Toner

The constitutional materials in the case where the toner in the invention is the light coloring type toner, and materials and methods used upon preparing the constitutional materials will be described in more detail below.

In this case, the toner contains at least the first component, the second component, the microcapsules containing the first component, and the photo-curable composition containing the second component and the photopolymerizable compound, and the photo-curable composition may contain a photopolymerization initiator (or a photopolymerization initiator system) and may also contain a spectral sensitizing dye or various kinds of assistants. The first component may be contained in the microcapsules (core) in a solid state or along with a solvent.

In the light coloring type toner, an electron donative colorless dye may be used as the first component, an electron acceptive compound (hereinafter, referred to as an electron acceptive developer or a developer in some cases) may be used as the second component, and a polymerizable compound having an ethylenic unsaturated bond may be used as the photopolymerizable compound in the first light coloring type toner. The constitutional components including the electron donative colorless dye as the first component, the spectral sensitizing dye and the various assistants, and the method of microencapsulation may be the same as those described hereinabove for the light non-coloring type toner.

In addition to the aforementioned materials, various kinds of materials having been used as materials constituting a conventional toner using a colorant, such as a binder resin, a releasing agent, an internal additive and external additive, may be appropriately used depending on necessity, as similar to the case of the light non-coloring type toner.

### Polymerizable Compound Having Ethylenic Unsaturated Bond (Photopolymerizable Compound)

The polymerizable compound having an ethylenic unsaturated bond that can be used in the invention may be a polymerizable compound having at least one ethylenic unsaturated double bond in the molecule.

Examples thereof include an acrylic acid and a salt thereof, an acrylate ester compound, an acrylamide compound, a methacrylic acid and a salt thereof, a methacrylate ester compound, a methacrylamide compound, maleic anhydride, a maleate ester compound, itaconinc acid, an itaconate ester, a styrene compound, a vinyl ether compound, a vinyl ester compound, an N-vinylheterocyclic compound, an aryl ether compound and an allyl ester compound. Among these, such a polymerizable compound is preferred that contains a heteroatom having at least one lone electron pair in the molecule.

The heteroatom having a lone electron pair referred herein designates such an atom as oxygen, nitrogen, sulfur, phosphorous and a halogen. Specific examples of the compound include compounds having an ester bond, an amide bond, a carbonyl bond, a thiocarbonyl bond, an ether bond, a thioether bond, and a group, such as amine, alcohol, thioalcohol, phosphine and halogen. Among these, such a polymerizable compound having an ethylenic unsaturated bond is preferred that has at least one of an ester bond, an amide bond, an amine group, a carbonyl bond and an ether bond, which have strong mutual interaction with the electron acceptive developer, and a compound having an ester bond or an amide bond and having a photopolymerizability is particularly preferred.

In order to improve the polymerization efficiency (curing rate), a polymerizable compound having plural ethylenic unsaturated double bonds in the molecule may be used, and examples thereof include an acrylate ester or a methacrylate ester of a polyhydric alcohol, such as trimethylolpropane and pentaerythritol, an acrylate or methacrylate-terminated epoxy resin, and an acrylate or methacrylate-terminated polyester.

### Photopolymerization Initiator (or Photopolymerization Initiator System)

The photopolymerization initiator used in the invention may be selected from one or a combination of two or more selected from compounds capable of initiating photopolymerization of the compound having an ethylenic unsaturated bond.

Specific examples of the photopolymerization initiator include an aromatic ketone compound, such as benzophenone, 4,4′-bis(dimethylamino)benzophenone, 4-methoxy-4′-dimethylaminobenzophenone, 4,4′-dimethoxybenzophenone, 4-dimethylaminobenzophenone, 4-dimethylaminoacetophenone, benzyl, anthraquinone, 2-tert-butylanthraquinone, 2-methylanthraquinone, xanthone, thioxanthone, 2-chlorothioxanthone, 2,4-diethylthioxanthone, fluorenone and acridone; benzoin and a benzoin ether compound, such as benzoin methyl ether, benzoin ethyl ether, benzoin isopropyl ether and benzoin phenyl ether; a 2,4,5-triarylimidazole dimer, such as a 2-(o-chlorophenyl)-4,5-diphenylimidazole dimer, a 2-(o-chlorophenyl)-4,5-di(m-methoxyphenyl)imidazole dimer, a 2-(o-fluorophenyl)-4,5-diphenylimidazole dimer, a 2-(o-methoxyphenyl)-4,5-diphenylimidazole dimer and a 2-(p-methoxyphenyl)-4,5-diphenylimidazole dimer; a polyhalogenated compound, such as carbon tetrabromide, phenyltribromomethylsulfone, phenyl trichloromethyl ketone and a compound disclosed in JP-A-53-133428, JP-B-57-1819, JP-B-57-6096 and U.S. Pat. No. 3,615,455, an S-triazine derivative having a trihalogen-substituted methyl group disclosed in JP-A-58-29803, e.g., 2,4,6-tris(trichloromethyl)-S-triazine, 2-methoxy-4,6-bis(trichloromethyl)-S-triazine, 2-amino-4,6-bis(trichloromethyl)-S-triazine and 2-(p-methoxystyryl)-4,6-bis(trichloromethyl)-S-triazine; an organic peroxide disclosed, for example, in JP-A-59-189340, such as methyl ethyl ketone peroxide, cyclohexanone peroxide, 3,3,5-trimethylcyclohexanone peroxide, benzoyl peroxide, di-tert-butyl diperoxyisophthalate, 2,5-dimethyl-2,5-di(benzoylperoxy)hexane, tert-butyl peroxybenzoate, a,a′-bis(tert-butylperoxyisopropyl)benzene, dicumyl peroxide and 3,3′4,4′-tetra(tert-butylperoxycarbonyl)benzophenone; an adinium compound disclosed, for example, in U.S. Pat. No. 4,743,530; an organic boron compound disclosed, for example, in European Patent No. 0,223,587, such as a tetramethylammonium salt of triphenylbutyl borate, a tetrabutylammonium salt of triphenylbutyl borate and a tetramethylammonium salt of tri(p-methoxyphenyl)butyl borate; a diaryliodonium salt; and an iron allene complex, which are known photopolymerization initiators in the field of photosensitive or heat-sensitive recording materials.

The content of the photopolymerization initiator is preferably from 0.01 to 20% by mass, more preferably from 0.2 to 15% by mass, and most preferably from 1 to 10% by mass, based on the total weight of the photo-curable composition. In the case where the content is less than 0.01% by mass, the sensitivity might be insufficient, and in the case where the content exceeds 20% by mass, no further improvement in sensitivity might be expected in some cases.

### Electron Acceptive Developer (Second Component)

Examples of the electron acceptive developer include a phenol derivative, a sulfur-containing phenol derivative, an organic carboxylic acid derivative (such as salicylic acid, stearic acid and resorcinol acid), metallic salts thereof, a sulfonic acid derivative, urea and thiourea derivatives, acid clay, bentonite, a novolac resin, a metal-treated novolac resin and a metallic complex.

These examples are disclosed in “Kami Pulp Gijutsu Taimusu” (Journal of Paper and Pulp Technologies) (1985), p. 49-54 and 65-70, and JP-B-40-9309, JP-B-45-14039, JP-A-52-140483, JP-A-48-51510, JP-A-57-210886, JP-A-58-87089, JP-A-59-11286, JP-A-60-176795 and JP-A-61-95988.

These electron acceptive compounds may be used solely or in combination of plural kinds thereof. The using amount of the electron acceptive compound is preferably in a range of from 10 to 4,000% by mass, and particularly preferably from 100 to 2,000% by mass, based on the amount of the electron donative colorless dye.

In addition to these compounds, the photo-curable composition may contain a thermal polymerization inhibitor depending on necessity. The thermal polymerization inhibitor is added for preventing thermal polymerization or time-lapse polymerization of the photo-curable composition from occurring, whereby the chemical stability of the photo-curing composition upon preparation and storage can be improved. Examples of the thermal polymerization inhibitor include p-methoxyphenol, hydroquinone, t-butylcatechol, pyrogallol, 2-hydroxybenzophenone, 4-methoxy-2-hydroxybenzophenone, cuprous chloride, phenothiazine, chloranil, naphthylamine, β-naphthol, 2,6-di-t-butyl-p-cresol, nitrobenzene, dinitrobenzene, picric acid and p-toluidine. The addition amount of thermal polymerization inhibitor is preferably from 0.001 to 5% by mass, and more preferably from 0.01 to 1% by mass, based on the total weight of the photo-curable composition. In the case where the addition amount thereof is less than 0.001% by mass, the thermal stability might be inferior, and in the case where it exceeds 5% by mass, the sensitivity might be lowered.

The photo-curable composition may be used after encapsulating in microcapsules depending on necessity. For example, the photo-curable composition may be encapsulated in microcapsules according to or with reference to European Patent No. 0,223,587.

The volume average particle diameter of the microcapsules is preferably adjusted to a range of from 0.1 to 3 μm, and more preferably a range of from 0.3 to 1.0 μm, as similar to the case of the light coloring type toner.

The electron donative colorless dye may be present in the microcapsules in the form of a solution or in the form of a solid. In the case where a solvent is used in combination, the amount of the solvent present in the microcapsules may be from 1 to 500 parts by mass per 100 parts by mass of the electron donative colorless dye.

The toner of the invention may contain an ultraviolet light absorbent for such a purpose as improvement in light fastness of an image depending on necessity. Examples of the ultraviolet light absorbent include a benzotriazole compound, a cinnamate ester compound, an aminoallylidenemalonitrile compound and a benzophenone compound, which have been known in the art.

In the case where the toner of the invention is produced by a wet production method, such as the aggregation and integration method described later, a dispersion liquid having the microcapsules dispersed therein and a dispersion liquid having the photo-curable composition dispersed therein are prepared. Examples of a solvent used for preparation of the dispersion liquids include water; an alcohol, such as methanol, ethanol, n-propanol, isopropanol, n-butanol, sec-butanol, methylcellosolve and 1-methoxy-2-propanol; a halogen solvent, such as methylene chloride and ethylene chloride; a ketone solvent, such as acetone, cyclohexanone and methyl ethyl ketone; an ester solvent, such as methylcellosolve acetate, ethyl acetate and methyl acetate; toluene; and xylene, which may be used solely or as a mixture of plural kinds thereof. Among these, water is preferably used.

### Other Components

With respect to the other components than disclosed hereinabove, the binder resin, the releasing agent and the other additives used in the light coloring type toner may be the same as those used in the light non-coloring type toner having been described. The particle diameter and the shape of the toner may be the same as those in the light non-coloring type toner.

The materials described for the light coloring type toner may be used in the light non-coloring type toner, and the materials described for the light non-coloring type toner may be used in the light coloring type toner, unless the coloring characteristics and the coloring control are impaired.

### Production Method of Toner

The production method of the toner will be described specifically.

The toner used in the invention may be produced by utilizing a known wet method, such as an aggregation and integration method. The wet method is suitable in the case where the toner has a constitution where coloration is attained by diffusion of substances upon heating (for example, the two or more kinds of reactive components are contained in the different matrices, respectively). Furthermore, the maximum process temperature upon production of the toner can be suppressed to low by utilizing the wet method, whereby coloration during the production process of the toner can be prevented from occurring.

The maximum process temperature of the wet method used is preferably 90° C. or less, and more preferably 80° C. or less, from the standpoint of prevention of coloration during production of the toner. In the case where the process temperature is too low, however, the production of the toner might become difficult, and thus the maximum process temperature is preferably 40° C. or more.

The use of the wet method may be applied for production of the toner having such a structure that contains the first component and the second component, which undergo coloration upon reacting with each other, the photo-curable composition, and the microcapsules dispersed in the photo-curable composition, in which the first component is contained in the microcapsules, and the second component is contained in the photo-curable composition.

The microcapsules used in the toner having the aforementioned structure may be heat-responsive microcapsules, and may also be microcapsules responsive to other stimulation, such as light.

The wet method may be used for producing the toner, and an aggregation and integration method may be used since the maximum process temperature can be suppressed to low among the wet methods, and toners having various structures, such as those exemplified in FIGS. 6 and 7, can be easily produced.

The toner having the aforementioned structure contains a large amount of the photo-curable composition containing low molecular weight component as major components as compared to a conventional toner containing a pigment and a binder resin as major components, and thus tends to be insufficient in strength of the particles obtained through granulation of the toner. However, the aggregation and integration method may be employed since no strong shearing force is required.

The production method of the toner utilizing the aggregation and integration method will be described in detail. In the aggregation and integration method, in general, after preparing dispersion liquids containing materials constituting the toner, an aggregating step of forming aggregated particles in the raw material dispersion liquids obtained by mixing two or more kinds of the dispersion liquids, and an integrating step of integrating the aggregated particles formed in the material dispersion liquid are effected, and depending on necessity, an adhering step of adhering a component for forming a covering layer on the surface of the aggregated particles to form a covering layer (covering layer forming step) is carried out between the aggregating step and the integrating step.

In the production of the toner used in the invention, the aggregating step and the integrating step may be used for producing the toner associated with the adhering step depending on necessity, with variations in species and combinations of the dispersion liquids used as raw materials.

The production method of the toner having the coloring part dispersed structure exemplified in FIG. 6 and the toner having the concentric structure exemplified in FIG. 7 utilizing the aggregation and integration method will be described in more detail below.

### A. Production Method of Toner Having Coloring Part Dispersed Structure

The production method of the toner having the coloring part dispersed structure utilizing the aggregation and integration method will be described.

The following steps are carried out to prepare at least one of photosensitive and heat-sensitive capsule dispersion liquids capable of being colored in different colors: (a1) a first aggregating step of forming first aggregating particles in a raw material dispersion liquid containing a microcapsule dispersion liquid having dispersed therein microcapsules containing the first component and a photo-curable composition dispersion liquid having dispersed therein the photo-curable composition containing the second component, (b1) an adhering step of adhering resin particles on the surface of the first aggregated particles by adding a first resin particle dispersion liquid having dispersed therein the resin particles to the raw material dispersion liquid having the first aggregated particles formed therein, and (c1) a first integrating step of heating the raw material dispersion liquid containing the aggregated particles having the resin particles adhered on the surface thereof to obtain first integrated particles (photosensitive and heat-sensitive capsules).

Subsequently, the following steps are carried out to prepare a toner having the coloring part dispersed structure: (d1) a second aggregating step of forming second aggregated particles in a mixed solution obtained by mixing the at least one of photosensitive and heat-sensitive capsule dispersion liquids and a second resin particle dispersion liquid having dispersed therein resin particles, and (e1) a second integrating step of heating the mixed solution containing the second aggregated particles to obtain second integrated particles.

The number of kinds of the photosensitive and heat-sensitive capsule dispersion liquids subjected to the second aggregating step may be two or more kinds. The photosensitive and heat-sensitive capsules obtained through the steps (a1) to (c1) may be used as a toner, i.e., a toner having only one coloring part.

### Preparation of Dispersion Liquids

The preparation methods of the dispersion liquids used in the production method of the toner utilizing the aggregation and integration method will be described.

The resin particle dispersion liquid may be prepared in such a manner that resin particles produced by emulsion polymerization or the like are dispersed in a solvent by using an ionic surfactant, or in alternative, a resin is dispersed in a solvent capable of dissolving the resin and then subjecting to phase inversion emulsification. Examples of the dispersion medium in the resin particle dispersion liquid include an aqueous medium and an organic solvent.

A releasing agent dispersion liquid may be prepared in such a manner that a releasing agent is dispersed in water along with an ionic surfactant or a polymer electrolyte, such as a polymer acid or a polymer base, and formed into fine particles with such an apparatus capable of applying a strong shearing force under heating to a temperature above the melting point.

Examples of the apparatus for fine dispersion include Manton Gorin High-pressure Homogenizer (Gorin Inc.), Continuous Ultrasonic Homogenizer (Nippon Seiki Co., Ltd.), Nanomizer (TOKAI Co., Ltd.), Microfluidizer (Mizuho Industrial Co., Ltd.), Burrell Homogenizer, Slasher (Mitsui Mining Co., Ltd.) and Cavitron (Eurotec, Ltd.).

The microcapsule dispersion liquid may be an emulsified liquid obtained by dispersing microcapsules produced by the aforementioned microencapsulation method in a solution containing an aqueous binder.

The photo-curable composition dispersion liquid may be obtained in such a manner that a resin component, such as a water soluble binder, and a solvent component, such as water, and surfactant and the like are added to the components constituting the photo-curable composition, and the mixture is formed into fine particles with an apparatus capable of applying a strong shearing force.

The particle diameter of the fine particles contained in the dispersion liquids other than the microcapsule dispersion liquid is preferably 1 μm or less, and more preferably in a range of from 100 to 300 nm, for facilitating adjustment of the toner diameter and particle diameter distribution to desired ranges.

(a1) First Aggregating Step

In the first aggregating step, first aggregating particles are formed in a raw material dispersion liquid containing a microcapsule dispersion liquid having dispersed therein microcapsules containing the first component and a photo-curable composition dispersion liquid having dispersed therein the photo-curable composition containing the second component.

In the first aggregating step, an aggregating agent is added to the raw material dispersion liquid, which is then heated depending on necessity, to aggregate the fine particles in the raw material dispersion liquid, whereby the first aggregated particles are formed.

The heating temperature may be from room temperature to 40° C., and may be increased to about 60° C. depending on necessity.

The aggregated particles are formed by adding an aggregating agent at room temperature under agitation with a rotation shearing homogenizer or the like, and making the pH of the raw material dispersion liquid to acidic (pH of about from 2 to 4).

The aggregating agent used in the first aggregating step may be a surfactant having a polarity contrary to the surfactant used as a dispersant added to the raw material dispersion liquid, i.e., may be an inorganic metallic salt and a divalent or higher metallic complex. The use of the metallic complex is preferred since the using amount of surfactant can be reduced to improve the charging property.

(b1) Adhering Step

In the adhering step, resin particles are adhered on the surface of the first aggregated particles by adding a first resin particle dispersion liquid having dispersed therein the resin particles to the raw material dispersion liquid having the first aggregated particles formed therein. According to the operation, a covering layer corresponding to the outer shell of the photosensitive and heat-sensitive capsules can be formed.

The covering layer can be formed by further adding the first resin particle dispersion liquid to the dispersion liquid having the aggregated particles (core particles) having been formed therein in the aggregating step. The binder resin component used in the first resin particle dispersion liquid may be a crystalline resin or a non-crystalline resin, and a releasing agent dispersion liquid may be used in combination with the first resin particle dispersion liquid. A releasing agent dispersion liquid may be used instead of the first resin particle dispersion liquid.

A surfactant may be used upon emulsion polymerization of the binder resin, dispersion of the fine particle components, aggregation of the fine particles, stabilization of the aggregated particles, or the like. Specific examples of the surfactant include an anionic surfactant, such as a sulfate ester series, a sulfonate salt series, a phosphate ester series and a soap series, and a cationic surfactant, such as an amine salt series and a quaternary ammonium salt series, and a nonionic surfactant, such as a polyethylene glycol series, an alkylphenol ethylene oxide adduct series and a polyhydric alcohol series, may be used in combination. Examples of the dispersion apparatus include ordinary ones, such as a rotation shearing homogenizer and a dispersion apparatus having a medium, such as a ball mill, a sand mill and a Dinor mill.

(c1) First Integrating Step

In the first integrating step, the raw material dispersion liquid containing the aggregated particles having the resin particles adhered on the surface thereof is heated to obtain first integrated particles (photosensitive and heat-sensitive capsules).

In the first integrating step, the pH of the dispersion liquid containing the aggregated particles obtained through the first aggregating step and the adhering step is made into a range of about from 6.5 to 8.5 to terminate progress of aggregation, and then the dispersion liquid is heated to integrate the aggregated particles.

The dispersion liquid may be heated to a temperature equal to or higher than the glass transition temperature or the melting point of the binder resin (and/or the releasing agent) used for forming the covering layer.

The heating temperature is set around such a temperature that prevents the outer shell structure of the microcapsules from being broken due to dissolution or the like of the materials constituting the outer shell, and in general, is determined in consideration of the heat resistance of the materials constituting the outer shell of the microcapsules, and the temperature, at which the materials constituting the outer shell of the microcapsules are capable of being integrated. The temperature is generally in a range of from 40 to 90° C., and preferably a range of from 50 to 80° C.

In the case where the heating temperature exceeds 90° C., the outer shell of the microcapsules might be broken to exert coloration, and in the case where the heating temperature is less than 40° C., the integration operation might not be effected sufficiently, and the photosensitive and heat-sensitive capsule particles might be decomposed in the later steps in some cases.

(d1) Second Aggregating Step

The steps (a1) to (c1) are carried out for each of the kinds of the photosensitive and heat-sensitive capsules dispersed in the toner (i.e., for each of the colors to be exhibited), and two or more kinds of photosensitive and heat-sensitive capsule dispersion liquids capable of being colored in different colors are prepared.

Subsequently, in the second aggregating step, second aggregated particles are formed in a mixed solution obtained by mixing the two or more photosensitive and heat-sensitive capsule dispersion liquids and a second resin particle dispersion liquid having dispersed therein resin particles. Dispersion liquids of other components, such as a releasing agent dispersion liquid, may be added to the mixed solution depending on necessity.

The second aggregating step may be carried out basically in the same manner as in the first aggregating step except that the formulations of the liquids used for aggregation are different therefrom. That is, an aggregating agent is added to the mixed dispersion liquid, which is then heated to aggregate the photosensitive and heat-sensitive capsule particles and the resin particles in the mixed dispersion liquid, whereby the second aggregated particles are formed. A resin particle dispersion liquid having dispersed therein amorphous resin particles may be added during the formation of the second aggregated particles or after completing the formation, so as to cover the surface of the second aggregated particles with the amorphous resin particles.

The heating temperature may be such a temperature that the amorphous resin particles are capable of being integrated with the amorphous resin particles or the other materials by heating, and specifically may be a temperature higher than the glass transition temperature of the amorphous resin particles by several degree to several tens degree.

(e1) Second Integrating Step

In the second integrating step, the mixed solution containing the second aggregated particles is heated to obtain second integrated particles (toner in wet state).

In the second integrating step, the pH of the dispersion liquid containing the aggregated particles obtained through the second aggregating step is made into a range of about from 6.5 to 8.5 to terminate progress of aggregation, and then the dispersion liquid is heated to integrate the aggregated particles.

The dispersion liquid may be heated to a temperature equal to or higher than the glass transition temperature or the melting point of the binder resin used for forming the second aggregated particles.

The heating temperature is determined in consideration of the heat resistance of the materials constituting the outer shell of the microcapsules, the heat resistance of the materials constituting the outer shell of the photosensitive and heat-sensitive capsules, and the temperature, at which the binder resin used for forming the second aggregated particles is capable of being integrated. The temperature is generally in a range of from 40 to 90° C., and preferably a range of from 50 to 70° C.

In the case where the heating temperature exceeds 90° C., the outer shell of the microcapsules might be broken to exert coloration, and the second component dispersed in the photosensitive and heat-sensitive capsules colored in one color might be diffused outside the photosensitive and heat-sensitive capsules, or might be diffused into the photosensitive and heat-sensitive capsules colored in another color, to fail to obtain sufficient coloration upon forming an image.

In the case where the heating temperature is less than 40° C., the integration operation might not be effected sufficiently, and the toner particles might be decomposed in the later steps, such as a washing step and a drying step, in some cases.

### Washing Step, Drying Step, etc.

After completing the second integrating step, the target particles are obtained through a washing step, a solid-liquid separating step and a drying step, which may be arbitrarily carried out. The washing step may be effected by carrying out substitution washing sufficiently with ion exchanged water in consideration of charging property. The solid-liquid separating step is not particularly limited, and suction filtration and pressurizing filtration may be employed in consideration of productivity. The drying step is not particularly limited, and freeze drying, flash jet drying, fluidized drying, vibration fluidized drying and the like may be employed in consideration of productivity. The toner particles after drying may be added with various kinds of external additives depending on necessity, as having been described.

### B. Production Method of Toner Having Concentric Structure

The production method of the toner having the concentric structure utilizing the aggregation and integration method will be described.

The following steps are carried out to prepare a photosensitive and heat-sensitive capsule dispersion liquid: (a2) a first aggregating step of forming first aggregating particles in a raw material dispersion liquid containing a first microcapsule dispersion liquid having dispersed therein first microcapsules containing the first component and a first photo-curable composition dispersion liquid having dispersed therein the photo-curable composition containing the second component, (b2) an adhering step of adhering resin particles on the surface of the first aggregated particles by adding a first resin particle dispersion liquid having dispersed therein the resin particles to the raw material dispersion liquid having the first aggregated particles formed therein, and (c2) a first integrating step of heating the raw material dispersion liquid containing the aggregated particles having the resin particles adhered on the surface thereof to prepare photosensitive and heat-sensitive capsules.

Subsequently, the following steps are carried out to prepare a toner having the concentric structure: (d2) a photosensitive and heat-sensitive layer forming step of forming a photosensitive and heat-sensitive layer capable of being colored in a color different from the aforementioned photosensitive and heat-sensitive capsules formed in the step (c2), by adding a raw material dispersion liquid containing a second microcapsule dispersion liquid having dispersed therein microcapsules containing the first component and a second photo-curable composition dispersion liquid having dispersed therein a photo-curable composition containing the second component, to the aforementioned photosensitive and heat-sensitive capsule dispersion liquid, (e2) a covering layer forming step of forming a covering layer by adhering resin particles on the surface of the photosensitive and heat-sensitive layer by adding a second resin particle dispersion liquid having dispersed therein the resin particles to the raw material dispersion liquid having been subjected to the photosensitive and heat-sensitive layer forming step, and (f2) a second integrating step of heating the raw material dispersion liquid containing the second aggregated particles having the covering layer by adhering the resin particles to the surface of the photosensitive and heat-sensitive layer, to obtain second integrated particles.

In the case where a toner having the concentric structure having three or more coloring parts capable of being colored in different colors is produced, respectively, the process containing the photosensitive and heat-sensitive layer forming step (d2), the covering layer forming step (e2) and the second integrating step (f2) effected in this order is repeated once of more. According to the operation, two or more photosensitive and heat-sensitive layers and photosensitive and heat-sensitive capsules capable of being colored in different colors, respectively, can be formed through the respective photosensitive and heat-sensitive layer forming steps.

Other dispersion liquids may be used in the steps depending on necessity, and for example, a releasing agent dispersion liquid may be used in the first aggregating step, the adhering step, the photosensitive and heat-sensitive layer forming step and the covering layer forming step.

The steps will be described in more detail. The preparation methods of the dispersion liquids used in the steps may be the same as in the production of the toner having the photosensitive and heat-sensitive capsule dispersed structure.

The steps (a2) to (c2) may be carried out basically in the same manner as the steps (a1) to (c1), provided that only one kind of the photosensitive and heat-sensitive capsule dispersion liquid is prepared in the steps (a2) to (c2).

The photosensitive and heat-sensitive layer forming step (d2) and the covering layer forming step (e2) carried out subsequently may be carried out basically in the same manner as in the steps (a1) and (b1) except that the photosensitive and heat-sensitive layer and the covering layer are accumulated sequentially on the photosensitive and heat-sensitive capsule particles as a core layer (core particles). According to the operation, the second aggregated particles are obtained that have the photosensitive and heat-sensitive capsule particles as a core layer, on which the photosensitive and heat-sensitive layer and the covering layer are accumulated to cover the core layer.

The covering layer formed in the covering layer forming step (e2) constitutes a surface layer covering the toner surface upon forming the toner finally, or constitutes an intermediate layer provided between two photosensitive and heat-sensitive layers adjacent to each other. In the case where the covering layer constitutes the surface layer upon forming the toner finally, a resin particle dispersion liquid using an amorphous resin may be used in the covering layer forming step (e2).

The second integrating step (f2) may be carried out basically in the same manner as in the step (e1). The heating temperature in the second integrating step is determined in consideration of the heat resistance of the materials constituting the outer shell of the microcapsules, the heat resistance of the materials constituting the outer shell of the photosensitive and heat-sensitive capsules and (in the case where the steps (d2) to (f2) are repeated twice or more) the intermediate layer, and the temperature, at which the binder resin used for forming the second aggregated particles is capable of being integrated. The temperature is generally in a range of from 40 to 90° C., and preferably a range of from 50 to 80° C.

In the case where the heating temperature exceeds 90° C., the outer shell of the microcapsules might be broken to exert coloration, and the second component dispersed in the coloring part (the photosensitive and heat-sensitive capsules and/or the photosensitive and heat-sensitive layer) colored in one color might be diffused outside the coloring part (the photosensitive and heat-sensitive capsules and/or the photosensitive and heat-sensitive layer), or might be diffused into the coloring part (the photosensitive and heat-sensitive capsules and/or the photosensitive and heat-sensitive layer) colored in another color, to fail to obtain sufficient coloration upon forming an image.

In the case where the heating temperature is less than 40° C., the integration operation might not be effected sufficiently, and the toner particles might be decomposed in the later steps, such as a washing step and a drying step, in some cases.

After completing the aforementioned sequence of steps, the washing step, the drying step and the like may be similarly carried out to obtain a toner.

The volume average particle diameter of the toner used in the invention is not particularly limited, and may be appropriately adjusted corresponding to the structure of the toner and the kind and number of the coloring parts contained in the toner.

In the case where the number of the coloring parts capable of being colored in different colors contained in the toner is about 2 to 4 (for example, the toner contains three coloring parts capable of being colored in yellow, cyan and magenta, respectively), the volume average particle diameter of the toner may be in the following ranges corresponding to the structure of the toner.

In the case where the toner has the coloring part dispersed structure as exemplified in FIG. 6, the volume average particle diameter of the toner is preferably in a range of from 5 to 40 μm, and more preferably a range of from 10 to 20 μm. The volume average particle diameter of the photosensitive and heat-sensitive capsules contained in the toner having the photosensitive and heat-sensitive capsule dispersed structure and having a particle diameter in the aforementioned range is preferably in a range of from 1 to 5 μm, and more preferably a range of from 1 to 3 μm.

In the case where the volume average particle diameter of the toner is less than 5 μm, the amount of the coloring component contained in the toner becomes small, whereby the color reproducibility might be deteriorated, and the image density might be reduced. In the case where the volume average particle diameter of the toner exceeds 40 μm, an image formed has large surface irregularity, whereby irregularity in gloss might occur on the surface of the image, and the image quality might be lowered.

A toner having the photosensitive and heat-sensitive capsule dispersed structure containing plural kinds of photosensitive and heat-sensitive capsules dispersed therein tends to have a larger particle diameter than the conventional small diameter toner using a colorant (having a volume average particle diameter of about from 5 to 10 μm). However, the resolution of the image formed is determined by the particle diameter of the photosensitive and heat-sensitive capsules but not the particle diameter of the toner, and therefore, a high definition image can be obtained. Furthermore, sufficient flowability can be ensured, and the developing property and the cleaning property can be improved even though small amount of externally additive is added, owing to the excellent powder flowability thereof.

In the case of toners having the concentric structure, the stripe structure and the flabellate structure as exemplified in FIGS. 7 to 9, the particle diameter can be easily decreased as compared to a toner having the photosensitive and heat-sensitive capsule dispersed structure since the formation of the photosensitive and heat-sensitive capsules in the form of particles may not be considered. The volume average particle diameter of the toner is preferably in a range of from 3 to 40 μm, and more preferably a range of from 5 to 15 μm. In the case where the volume average particle diameter of the toner is less than 3 μm, the toner might be difficult to produce. In the case where the volume average particle diameter of the toner exceeds 40 μm, irregularity in gloss might occur on the surface of the image, and the image quality might be lowered.

The toner in the invention may have a volume average particle size distribution index GSDv of 1.30 or less and a ratio of volume average particle size distribution index GSDv and number average particle size distribution index GSDp (GSDv/GSDp) of 0.95 or more.

More preferably, the volume average particle size distribution index GSDv is 1.25 or less, and the ratio of volume average particle size distribution index GSDv and number average particle size distribution index GSDp (GSDv/GSDp) is 0.97 or more.

In the case where the volume average particle size distribution index GSDv exceeds 1.30, the resolution of the image might be lowered, and in the case where the ratio of volume average particle size distribution index GSDv and number average particle size distribution index GSDp (GSDv/GSDp) is less than 0.95, deterioration in charging property of the toner, scattering of the toner, and fogging might occur, which bring about image defects.

In the invention, the volume average particle diameter, the volume average particle size distribution index GSDv and the number average particle size distribution index GSDp of the toner are measured and calculated in the following manner.

A cumulative distribution of volume and number of the toner particles is drawn from the small diameter side with respect to the respective particle diameter ranges (channels) obtained by dividing the particle size distribution of the toner measured by using such a measuring apparatus as Coulter Multisizer II (produced by Beckman Coulter, Inc.), and the particle diameters at a cumulative amount of 16% are designated as a volume average particle diameter D16v and a number average particle diameter D16p, particle diameters at a cumulative amount of 50% are designated as a volume average particle diameter D50v and a number average particle diameter D50p, and particle diameters at a cumulative amount of 84% are designated as a volume average particle diameter D84v and a number average particle diameter D84p. The volume average particle size distribution index GSDv and the number average particle size distribution index GSDp are calculated by using the relational expressions where the volume average particle size distribution index GSDv is defined as (D84v/D16v)^{1/2}, and the number average particle size distribution index GSDp is defined as (D84p/D16p)^{1/2}.

The volume average particle diameters of the microcapsules and the photosensitive and heat-sensitive capsules can be measured, for example, by using a laser diffraction particle size distribution measuring apparatus (LA-700, produced by Horiba, Ltd.).

The toner in the invention may have a shape factor SF1 represented by the following equation (2) in a range of from 110 to 130.

SF1=(ML²/A)×(π/4)×100 (2)

wherein ML represents the maximum length of the toner (μm), and A represents the projected area of the toner (μm²).

In the case where the shape factor SF1 is less than 110, the toner is liable to remain on the surface of the image carrying member upon the transferring step during the formation of an image, and the cleaning property upon cleaning the remaining toner with a blade or the like tends to be deteriorated, whereby image defects might occur in some cases.

In the case where the shape factor SF1 exceeds 130, the toner might be broken through collision with a carrier in a developing device (a toner feeding device) upon using the toner as a developer. In this case, fine powder is generated, whereby not only the releasing agent component might be exposed to the toner surface to contaminate the surface of the image carrying member, whereby deteriorating the charging property, but also fogging might occur due to the formation of fine powder.

The shape factor SF1 can be measured by using a Luzex image analyzer (FT, produced by Nireco Corp.) in the following manner. An optical micrograph of the toner scattered on slide glass is imported to a Luzex image analyzer through a video camera, and the maximum length (ML) and the projected area (A) are measured for 50 or more toner particles, and square of the maximum length and the projected area are calculated for the respective toner particles to obtain the shape factor SF1 according to the equation (2).

For the purposes of imparting flowability and improving the cleaning property, inorganic particles, such as silica, alumina, titania and calcium carbonate, and resin particles, such as a vinyl resin, polyester and silicone, may be added as a flowing assistant or a cleaning assistant to the toner surface in a dry state under application of shearing force, as similar to the ordinary toner.

Examples of the inorganic oxide fine particles added to the toner include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄ and MgSO₄. Among these, silica fine particles and titania fine particles are preferably used. The inorganic oxide fine particles may be subjected to a hydrophobic treatment on the surface thereof in advance. The hydrophobic treatment is effective for improvement in powder flowability of the toner and improvement in environmental dependency of the charging property and the contamination resistance of the carrier.

### Developer (Toner Supply)

The toner used in the invention may be used as it is as a one-component developer or may be used as a toner for a two-component developer containing a carrier and a toner.

The developer may be, from the standpoint that color image can be formed with only one kind of developer, (1) a developer containing one kind of the toner having two or more coloring parts containing the photo-curable composition and the microcapsules dispersed in the photo-curing composition, in which the two or more coloring parts contained in the toner are capable of being colored in different colors, respectively, or (2) a developer containing two or more toners as a mixture, each of which has one coloring part containing the photo-curable composition and the microcapsules dispersed in the photo-curing composition, in which the coloring parts of the two or more toners are capable of being colored in different colors, respectively.

In the developer of the former type (1), for example, three coloring parts are contained in the toner, and the three coloring parts are constituted by a yellow coloring part capable of being colored in yellow, a magenta coloring part capable of being colored in magenta and a cyan coloring part capable of being colored in cyan. In the developer of the latter type (2), for example, a yellow coloring toner having a coloring part capable of being colored in yellow, a magenta coloring toner having a coloring part capable of being colored in magenta and a cyan coloring toner having a coloring part capable of being colored in cyan are contained as a mixture in the developer.

The carrier capable of being used in the two-component developer may contain a core material and a resin covering the surface of the core material. The core material is not particularly limited as far as the aforementioned conditions are satisfied, and examples thereof include a magnetic metal, such as iron, steel, nickel and cobalt, an alloy of the magnetic metal with manganese, chromium, a rare earth metal or the like, and a magnetic oxide, such as ferrite and magnetite. Among these, ferrite and an alloy with manganese, lithium, strontium, magnesium or the like are preferred from the standpoint of the surface property and the resistance of the core material.

The resin covering the surface of the core material is not particularly limited and can be selected from those capable of being used as a matrix resin, depending on purposes.

The mixing ratio (mass ratio) of the toner of the invention and the carrier in the two-component developer (toner/carrier) may be in a range of about from 1/100 to 30/100, and preferably a range of about from 3/100 to 20/100.

### EXAMPLES

The invention will be described in more detail with reference to examples below, but the invention is not construed as being limited thereto. All the parts and the percents in the examples are parts by mass (substantially weight) and percents by mass (substantially weight), respectively.

### Production of Toner

A toner used in the examples will be described. In the following production method of a toner, preparation of the photo-curable composition dispersion liquid and production of a toner using the same are carried out in a dark place.

### A. Light Non-Coloring Type Toner

### Preparation of Microcapsule Dispersion Liquid

### Microcapsule Dispersion Liquid (1)

8.9 parts of an electron donative colorless dye (1) capable of being colored in yellow is dissolved in 16.9 parts of ethyl acetate, to which 20 parts of a capsule wall material (Takenate D-110N, a trade name, produced by Takeda Chemical Industries, Ltd.) and 2 parts of a capsule wall material (Millionate MR200, a trade name, produced by Nippon Polyurethane Co., Ltd.) are added.

The resulting solution is added to a mixed liquid of 42 parts of 8%-phthalated gelatin, 14 parts of water and 1.4 parts of a 10% sodium dodecylbenzenesulfonate aqueous solution, and subjected to emulsion dispersion at 20° C. to obtain an emulsion liquid. 72 parts of a 2.9% tetraethylenepentamine aqueous solution is added to the emulsion liquid, and the mixture is heated to 60° C. under stirring to obtain, after lapsing 2 hours, a microcapsule dispersion liquid (1) having an average particle diameter of 0.5 μm containing the electron donative colorless dye (1) in the core.

The material constituting the outer shell of the microcapsules contained in the microcapsule dispersion liquid (1) (which is a material obtained by reacting Takenate D-110N and Millionate MR200 under the substantially same conditions as above) has a glass transition temperature of 100° C.

### Microcapsule Dispersion Liquid (2)

A microcapsule dispersion liquid (2) is obtained in the same manner as the preparation of the microcapsule dispersion liquid (1) except that the electron donative colorless dye (1) is changed to an electron donative colorless dye (2). The microcapsules in the dispersion liquid have an average particle diameter of 0.5 μm.

### Microcapsule Dispersion Liquid (3)

A microcapsule dispersion liquid (3) is obtained in the same manner as the preparation of the microcapsule dispersion liquid (1) except that the electron donative colorless dye (1) is changed to an electron donative colorless dye (3). The microcapsules in the dispersion liquid have an average particle diameter of 0.5 μm.

The chemical structures of the electron donative colorless dyes (1) to (3) used for preparing the microcapsule dispersion liquids are shown below.

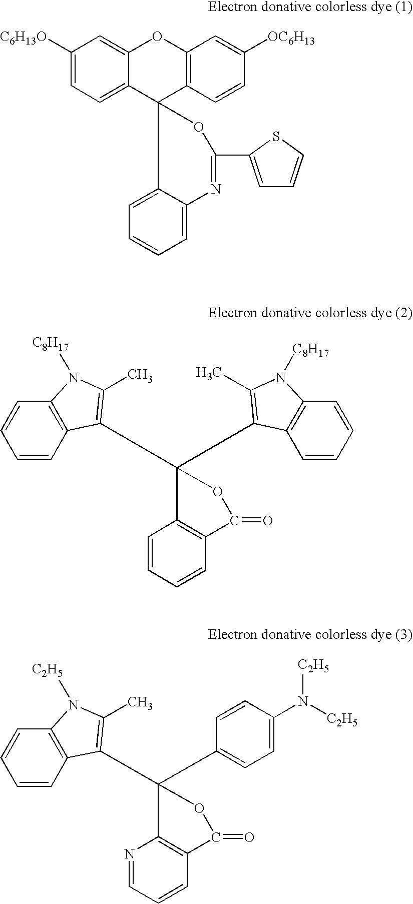

### Preparation of Photo-Curable Composition Dispersion Liquid

### Photo-Curable Composition Dispersion Liquid (1)

100.0 parts of a mixture of electron acceptive compounds (1) and (2) having a polymerizable group (mixing ratio: 50/50) and 0.1 part of a thermal polymerization inhibitor (ALI) are dissolved in 125.0 parts of isopropyl acetate (having a solubility in water of 4.3%) at 42° C. to obtain a mixed solution I.

18.0 parts of a hexaarylbiimidazole (1) (2,2′-bis(2-chlorophenyl)-4,4′,5,5′-tetraphenyl-1,2′-biimidazole), 0.5 part of a nonionic organic dye and 6.0 parts of an organic boron compound are added to and dissolved in the mixed solution I at 42° C. to obtain a mixed solution II.

The mixed solution II is added to a mixed solution of 300.1 parts of a 8% gelatin aqueous solution and 17.4 parts of a 10% surfactant (1) aqueous solution, and the resulting mixture is emulsified by using a homogenizer (produced by Nippon Seiki Co., Ltd.) at a rotation number of 10,000 for 5 minutes and then subjected to removal of solvents at 40° C. for 3 hours to obtain a photo-curable composition dispersion liquid (1) having a solid content of 30%.

### Photo-Curable Composition Dispersion Liquid (2)

5 parts of an electron acceptive compound having a polymerizable group (3) shown below is added to a mixed solution of 0.6 part of an organic borate compound (I) (borate compound I) shown below, 0.1 part of a spectral sensitizing dye borate compound (II) (borate compound II) shown below, 0.1 part of an assistant (1) for obtaining high sensitivity shown below and 3 parts of isopropyl acetate (having a solubility in water of 4.3%).

The resulting solution is added to a mixed solution of 13 parts of a 13% gelatin aqueous solution, 0.8 part of a 2% surfactant (2) (shown below) aqueous solution and 0.8 part of a 2% surfactant (3) (shown below) aqueous solution, and the resulting mixture is emulsified by using a homogenizer (produced by Nippon Seiki Co., Ltd.) at a rotation number of 10,000 for 5 minutes to obtain a photo-curable composition dispersion liquid (2).

### Photo-Curable Composition Dispersion Liquid (3)

A photo-curable composition dispersion liquid (3) is obtained in the same manner as the preparation of the photo-curable composition dispersion liquid (2) except that 0.1 part of the spectral sensitizing dye borate compound (II) (borate compound II) is used instead of the spectral sensitizing dye borate compound (I).

The structural formulae of the electron acceptive compound having a polymerizable group (1), the electron acceptive compound having a polymerizable group (2), the thermal polymerization inhibitor (ALI), the hexaarylbiimidazole (1), the surfactant (1), the nonionic organic dye and the organic boron compound used in the preparation of the photo-curable composition dispersion liquid (1) are shown below.

The structural formulae of the organic borate compound (I), the spectral sensitizing dye borate compound (I), the electron acceptive compound having a polymerizable group (3), the assistant (1), the surfactant (2), and surfactant (3) used in the preparation of the photo-curable composition dispersion liquid (2) are shown below.

The structural formula of the spectral sensitizing dye borate compound (II) used in the preparation of the photo-curable composition dispersion liquid (3) is shown below.

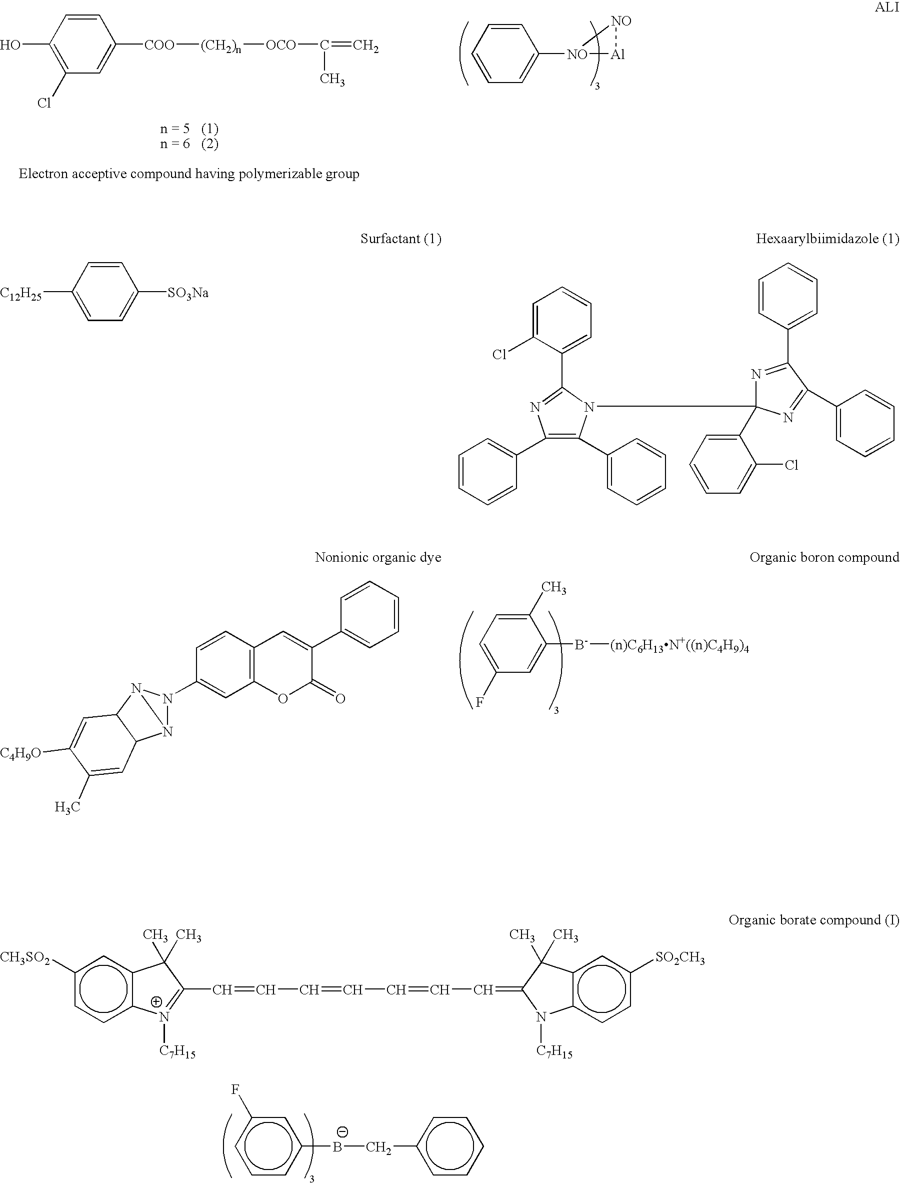

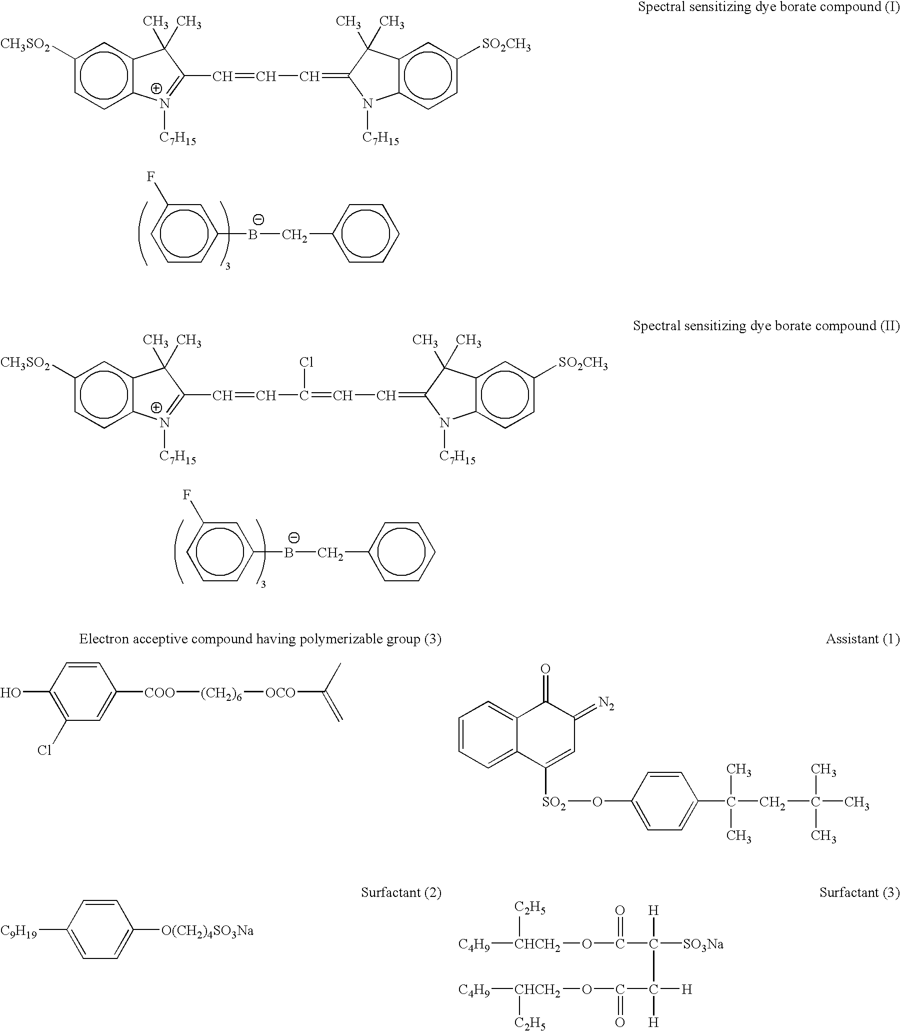

### Preparation of Resin Particle Dispersion Liquid

| | |
|---|---|
| Styrene | 460 parts |
| n-Butyl acrylate | 140 parts |
| Acrylic acid | 12 parts |
| Dodecanethiol | 9 parts |

The aforementioned components are mixed and dissolved to prepare a solution. Subsequently, the solution is dispersed and emulsified in a flask in a solution obtained by dissolving 12 parts of an anionic surfactant (Dowfax, produced by Rhodia, Inc.) in 250 parts of ion exchanged water to prepare an emulsion liquid (monomer emulsion liquid A).

1 part of an anionic surfactant (Dowfax, produced by Rhodia, Inc.) is dissolved in 555 parts of ion exchanged water and charged in a polymerization flask. The polymerization flask is sealed and equipped with a reflux tube, and the polymerization flask is heated to 75° C. over a water bath with nitrogen injected therein under slowly stirring, followed by being maintained.

A solution obtained by dissolving 9 parts of ammonium persulfate in 43 parts of ion exchanged water is added dropwise into the polymerization flask over 20 minutes by using a metering pump, and the monomer emulsion liquid A is then added dropwise into the polymerization flask over 200 minutes by using a metering pump.

Thereafter, the polymerization flask is maintained at 75° C. for 3 hours under slowly stirring continuously to complete polymerization.

According to the operation, a resin particle dispersion liquid containing particles having a median diameter of 210 nm, a glass transition point of 51.5° C. and a weight average molecular weight of 31,000, and having a solid content of 42% is obtained.

### Production of Toner 1 (Coloring Part Dispersed Structure)

### Preparation of Photosensitive and Heat-sensitive Capsule Dispersion Liquid (1)

| | |
|---|---|
| Microcapsule dispersion liquid (1) | 150 parts |
| Photo-curable composition dispersion liquid (1) | 300 parts |
| Polyaluminum chloride | 0.20 part |
| Ion exchanged water | 300 parts |

A raw material solution obtained by mixing the aforementioned components is adjusted to pH 3.5 by adding nitric acid thereto, and sufficiently mixed and dispersed with a homogenizer (Ultra-Turrax, produced by IKA Works, Inc.). The solution is then placed in a flask, heated 40° C. over a heating oil bath under stirring with Three-One Motor and maintained at 40° C. for 60 minutes, to which 300 parts of the resin particle dispersion is then added, followed by gradually stirring at 60° C. for 2 hours, so as to obtain a photosensitive and heat-sensitive capsule dispersion liquid (1).

The photosensitive and heat-sensitive capsules dispersed in the dispersion liquid have a volume average particle diameter of 3.53 μm. No spontaneous coloration of the dispersion liquid is observed upon preparation of the dispersion liquid.

### Preparation of Photosensitive and Heat-Sensitive Capsule Dispersion Liquid (2)

| | |
|---|---|
| Microcapsule dispersion liquid (2) | 150 parts |
| Photo-curable composition dispersion liquid (2) | 300 parts |
| Polyaluminum chloride | 0.20 part |
| Ion exchanged water | 300 parts |

A photosensitive and heat-sensitive capsule dispersion liquid (2) is prepared in the same manner as in the preparation of the photosensitive and heat-sensitive capsule dispersion liquid (1) except that the aforementioned components are used as the raw material solution.

The photosensitive and heat-sensitive capsules dispersed in the dispersion liquid have a volume average particle diameter of 3.52 μm. No spontaneous coloration of the dispersion liquid is observed upon preparation of the dispersion liquid.

### Preparation of Photosensitive and Heat-Sensitive Capsule Dispersion Liquid (3)

| | |
|---|---|
| Microcapsule dispersion liquid (3) | 150 parts |
| Photo-curable composition dispersion liquid (3) | 300 parts |
| Polyaluminum chloride | 0.20 part |
| Ion exchanged water | 300 parts |

A photosensitive and heat-sensitive capsule dispersion liquid (3) is prepared in the same manner as in the preparation of the photosensitive and heat-sensitive capsule dispersion liquid (1) except that the aforementioned components are used as the raw material solution.

The photosensitive and heat-sensitive capsules dispersed in the dispersion liquid have a volume average particle diameter of 3.47 μm. No spontaneous coloration of the dispersion liquid is observed upon preparation of the dispersion liquid.

### Production of Toner

| | |
|---|---|
| Photosensitive and heat-sensitive capsule dispersion liquid (1) | 750 parts |
| Photosensitive and heat-sensitive capsule dispersion liquid (2) | 750 parts |
| Photosensitive and heat-sensitive capsule dispersion liquid (3) | 750 parts |

A solution obtained by mixing the aforementioned components is placed in a flask and heated to 42° C. over a heating oil bath under stirring the content of the flask, and after maintaining at 42° C. for 60 minutes, 100 parts of the resin particle dispersion liquid is added under slowly stirring.

Thereafter, the content of the flask is adjusted to pH 5.0 by adding a 0.5 mol/L sodium hydroxide aqueous solution and then heated to 55° C. under stirring continuously. During the temperature increase to 55° C., the pH of the content of the flask is generally decreased to 5.0 or lower, but in this case, the pH is prevented from being decreased below 4.5 by adding dropwise the sodium hydroxide aqueous solution. The solution is then maintained at that state at 55° C. for 3 hours.

After completing the reaction, the content of the flask is cooled, filtered and sufficiently washed with ion exchanged water, and then subjected to solid-liquid separation by suction filtration with a Buchner funnel. The solid content is again dispersed in 3 L of ion exchanged water at 40° C. in a 5-L beaker and washed by stirring at 300 rpm for 15 minutes. The washing operation is repeated in five times, and the solid content is subjected to solid-liquid separation by suction filtration with a Buchner funnel and vacuum freeze drying for 12 hours to obtain toner particles having photosensitive and heat-sensitive capsules dispersed in a styrene resin. The measurement of the particle diameter of the toner particles with a Coulter Counter reveals that the volume average particle diameter D50v is 15.2 μm.

1.0 part of hydrophobic silica (TS720, produced by Cabot Oil & Gas Corp.) is added to 50 parts of the toner particles and mixed with a sample mill to obtain an externally added toner 1.

### Production of Toner 2 (Concentric Structure)

### Production of Toner

| | |
|---|---|
| Microcapsule dispersion liquid (1) | 150 parts |
| Photo-curable composition dispersion liquid (1) | 300 parts |
| Polyaluminum chloride | 0.20 part |
| Ion exchanged water | 300 parts |

A solution obtained by mixing the aforementioned components is adjusted to pH 3.5 with nitric acid, and sufficiently mixed and dispersed with a homogenizer (Ultra-Turrax T50, produced by IKA Works, Inc.). The solution is then placed in a flask, heated 40° C. over a heating oil bath under stirring with Three-One Motor and maintained at 40° C. for 60 minutes, to which 300 parts of the resin particle dispersion liquid is then added, followed by gradually stirring.

Thereafter, the content of the flask is adjusted to pH 7.5 with a 0.5 mol/L sodium hydroxide aqueous solution and then heated to 60° C. under stirring continuously, followed by gradually stirring at 60° C. for 2 hours. The content is taken out from the flask and cooled by standing to obtain a photosensitive and heat-sensitive capsule dispersion liquid.

The photosensitive and heat-sensitive capsules dispersed in the dispersion liquid have a volume average particle diameter of 4.50 μm. No spontaneous coloration of the dispersion liquid is observed upon preparation of the dispersion liquid.

Subsequently, a mixed solution of the following components is added to the photosensitive and heat-sensitive capsule dispersion liquid, adjusted to pH 3.5 with nitric acid, and sufficiently mixed and dispersed with a homogenizer (Ultra-Turrax T50, produced by IKA Works, Inc.).

| | |
|---|---|
| Microcapsule dispersion liquid (2) | 150 parts |
| Photo-curable composition dispersion liquid (2) | 300 parts |
| Polyaluminum chloride | 0.20 part |
| Ion exchanged water | 300 parts |

The solution having been mixed and dispersed is again placed in the flask, heated 40° C. over a heating oil bath under stirring with Three-One Motor and maintained at 40° C. for 60 minutes, to which 200 parts of the resin particle dispersion liquid is then added, followed by gradually stirring.

Thereafter, the content of the flask is adjusted to pH 7.5 with a 0.5 mol/L sodium hydroxide aqueous solution and then heated to 60° C. under stirring continuously, followed by gradually stirring at 60° C. for 2 hours. The content is taken out from the flask and cooled by standing to obtain a photosensitive and heat-sensitive capsule dispersion liquid.

The photosensitive and heat-sensitive capsules dispersed in the dispersion liquid have a volume average particle diameter of 6.0 μm. No spontaneous coloration of the dispersion liquid is observed upon preparation of the dispersion liquid.

Subsequently, a mixed solution of the following components is added to the photosensitive and heat-sensitive capsule dispersion liquid, adjusted to pH 3.5 with nitric acid, and sufficiently mixed and dispersed with a homogenizer (Ultra-Turrax T50, produced by IKA Works, Inc.).

| | |
|---|---|
| Microcapsule dispersion liquid (3) | 150 parts |
| Photo-curable composition dispersion liquid (3) | 300 parts |
| Polyaluminum chloride | 0.20 part |
| Ion exchanged water | 300 parts |

The solution having been mixed and dispersed is again placed in the flask, heated 40° C. over a heating oil bath under stirring with Three-One Motor and maintained at 40° C. for 60 minutes, to which 100 parts of the resin particle dispersion liquid is then added, followed by gradually stirring at 60° C. for 2 hours.

Thereafter, the content of the flask is adjusted to pH 5.0 with a 0.5 mol/L sodium hydroxide aqueous solution and then heated to 55° C. under stirring continuously. During the temperature increase to 55° C., the pH of the content of the flask is generally decreased to 5.0 or lower, but in this case, the pH is prevented from being decreased below 4.5 by adding dropwise the sodium hydroxide aqueous solution. The solution is then maintained at that state at 55° C. for 3 hours. No spontaneous coloration of the dispersion liquid is observed upon preparation of the dispersion liquid.

After completing the reaction, the content of the flask is cooled, filtered and sufficiently washed with ion exchanged water, and then subjected to solid-liquid separation by suction filtration with a Buchner funnel. The solid content is again dispersed in 3 L of ion exchanged water at 40° C. in a 5-L beaker and washed by stirring at 300 rpm for 15 minutes. The washing operation is repeated in five times, and the solid content is subjected to solid-liquid separation by suction filtration with a Buchner funnel and vacuum freeze drying for 12 hours to obtain toner particles.

The measurement of the particle diameter of the toner particles with a Coulter Counter reveals that the volume average particle diameter D50v is 7.5 μm. 1.0 part of hydrophobic silica (TS720, produced by Cabot Oil & Gas Corp.) is added to 50 parts of the toner particles and mixed with a sample mill to obtain an externally added toner 2.

### B. Light Coloring Type Toner

### Preparation of Microcapsule Dispersion Liquid

### Microcapsule Dispersion Liquid (1)

12.1 parts of the electron donative colorless dye (1) is dissolved in 10.2 parts of ethyl acetate, to which 12.1 parts of dicyclohexyl phthalate, 26 parts of Takenate D-110N, (produced by Takeda Chemical Industries, Ltd.) and 2.9 parts of Millionate MR200, (produced by Nippon Polyurethane Co., Ltd.) are added to prepare a solution.

The solution is added to a mixed liquid of 5.5 parts of polyvinyl alcohol and 73 parts of water, and subjected to emulsion dispersion at 20° C. to obtain an emulsion liquid having an average particle diameter of 0.5 μm. 80 parts of water is added to the emulsion liquid, and the mixture is heated to 60° C. under stirring to obtain, after lapsing 2 hours, a microcapsule dispersion liquid (1) containing the electron donative colorless dye (1) in the core.

The material constituting the outer shell of the microcapsules contained in the microcapsule dispersion liquid (1) (which is a material obtained by reacting dicyclohexyl phthalate, Takenate D-110N and Millionate MR200 under the substantially same conditions as above) has a glass transition temperature of about 130° C.

### Microcapsule Dispersion Liquid (2)

A microcapsule dispersion liquid (2) is obtained in the same manner as the preparation of the microcapsule dispersion liquid (1) except that the electron donative colorless dye (1) is changed to an electron donative colorless dye (2).

### Microcapsule Dispersion Liquid (3)

A microcapsule dispersion liquid (3) is obtained in the same manner as the preparation of the microcapsule dispersion liquid (1) except that the electron donative colorless dye (1) is changed to an electron donative colorless dye (3).

### Preparation of Photo-Curable Composition Dispersion Liquid

### Photo-Curable Composition Dispersion Liquid (1)

9 parts of an electron acceptive compound (1) and 7.5 parts of a trimethylolpropane triacrylate monomer (trifunctional acrylate, molecular weight: about 300) are added to a solution obtained by dissolving 1.62 parts of a photopolymerization initiator (1-a) and 0.54 part of a photopolymerization initiator (1-b) in 4 parts of an ethyl acetate.

The resulting solution is added to a mixed solution obtained by mixing 19 parts of a 15% PVA (polyvinyl alcohol) aqueous solution, 5 parts of water, 0.8 part of a 2% surfactant (1) aqueous solution and 0.8 part of a 2% surfactant (2) aqueous solution, and the mixture is emulsified by using a homogenizer (produced by Nippon Seiki Co., Ltd.) at a rotation number of 8,000 for 7 minutes to obtain a photo-curable composition dispersion liquid (1) as an emulsion liquid.

### Photo-Curable Composition Dispersion Liquid (2)

A photo-curable composition dispersion liquid (2) is obtained in the same manner as the preparation of the photo-curable composition dispersion liquid (1) except that the photopolymerization initiators (1-a) and (1-b) are changed to 0.08 part of a photopolymerization initiator (2-a), 0.18 part of a photopolymerization initiator (2-b) and 0.18 part of a photopolymerization initiator (2-c).

### Photo-Curable Composition Dispersion Liquid (3)

A photo-curable composition dispersion liquid (3) is obtained in the same manner as the preparation of the photo-curable composition dispersion liquid (2) except that the photopolymerization initiator (2-b) is changed to a photopolymerization initiator (3-b).

The structural formulae of the photopolymerization initiators (1-a), (1-b), (2-a), (2-b), (2-c) and (3-b), the electron acceptive compound (1) and the surfactants (1) and (2) used in the preparation of the photo-curable composition dispersion liquids are shown below.

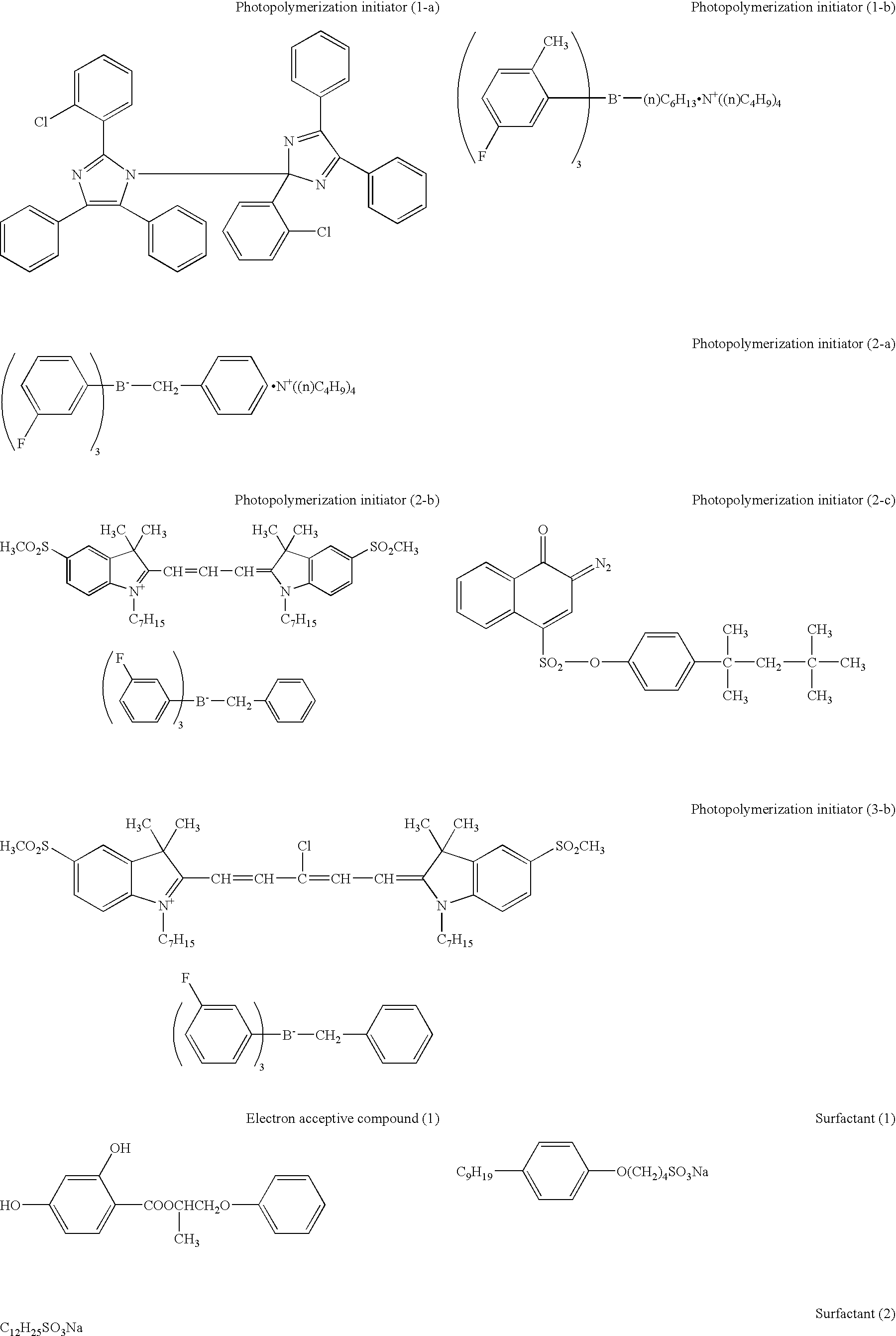

### Preparation of Resin Particle Dispersion Liquid (1)

| | |
|---|---|
| Styrene | 360 parts |
| n-Butyl acrylate | 40 parts |
| Acrylic acid | 4 parts |
| Dodecanethiol | 24 parts |
| Carbon tetrabromide | 4 parts |

A solution obtained by mixing and dissolving the aforementioned components is dispersed and emulsified in a flask in a solution obtained by dissolving 6 parts of a nonionic surfactant (Nonipol 400, produced by Sanyo Chemical Industries, Ltd.) and 10 parts of an anionic surfactant (Neogen SC, produced by Daiichi Kogyo Seiyaku Co., Ltd.) in 560 parts of ion exchanged water, to which 50 parts of ion exchanged water having 4 parts of ammonium persulfate dissolved therein is added over 10 minutes under slowly mixing.

Subsequently, after substituting the interior of the flask with nitrogen, the content of the flask is heated until the temperature thereof reaches 70° C. over an oil bath under stirring, and emulsion polymerization is continued under the condition for 5 hours. Thus, a resin particle dispersion liquid (1) (resin particle concentration: 30%) having resin particles having a volume average particle diameter of 200 nm, a glass transition temperature of 50° C., a weight average molecular weight (Mw) of 16,200 and a specific gravity of 1.2 dispersed therein is obtained.

### Preparation of Photosensitive and Heat-Sensitive Capsule Dispersion Liquid (1)

| | |
|---|---|
| Microcapsule dispersion liquid (1) | 24 parts |
| Photo-curable composition dispersion liquid (1) | 232 parts |

The aforementioned components are sufficiently mixed and dispersed in a stainless steel flask with Ultra-Turrax T50, produced by IKA Works, Inc.

The mixture is adjusted to pH 3 with nitric acid, to which 0.20 part of polyaluminum chloride is then added, and the dispersion operation is continued with Ultra-Turrax at a rotation number of 6,000 rpm for 10 minutes. The flask is heated to 40° C. over a heating oil bath under slowly stirring.

60 parts of the resin particle dispersion liquid (1) is gradually added to the flask.

According to the operation, a photosensitive and heat-sensitive capsule dispersion liquid (1) is obtained. The photosensitive and heat-sensitive capsules dispersed in the dispersion liquid have a volume average particle diameter of about 2 μm. No spontaneous coloration of the dispersion liquid is observed.

### Preparation of Photosensitive and Heat-Sensitive Capsule Dispersion Liquid (2)

A photosensitive and heat-sensitive capsule dispersion liquid (2) is obtained in the same manner as in the preparation of the photosensitive and heat-sensitive capsule dispersion liquid (1) except that the microcapsule dispersion liquid (1) is changed to the microcapsule dispersion liquid (2), and the photo-curable composition dispersion liquid (1) is changed to the photo-curable composition dispersion liquid (2). The photosensitive and heat-sensitive capsules dispersed in the dispersion liquid have a volume average particle diameter of about 2 μm. No spontaneous coloration of the dispersion liquid is observed.

### Preparation of Photosensitive and Heat-Sensitive Capsule Dispersion Liquid (3)

A photosensitive and heat-sensitive capsule dispersion liquid (3) is obtained in the same manner as in the preparation of the photosensitive and heat-sensitive capsule dispersion liquid (1) except that the microcapsule dispersion liquid (1) is changed to the microcapsule dispersion liquid (3), and the photo-curable composition dispersion liquid (1) is changed to the photo-curable composition dispersion liquid (3). The photosensitive and heat-sensitive capsules dispersed in the dispersion liquid have a volume average particle diameter of about 2 μm. No spontaneous coloration of the dispersion liquid is observed.

### Production of Toner 3 (Coloring Part Dispersed Structure)

### Production of Toner

| | |
|---|---|
| Photosensitive and heat-sensitive capsule dispersion liquid (1) | 80 parts |
| Photosensitive and heat-sensitive capsule dispersion liquid (2) | 80 parts |
| Photosensitive and heat-sensitive capsule dispersion liquid (3) | 80 parts |
| Resin particle dispersion liquid (1) | 80 parts |

The aforementioned components are sufficiently mixed and dispersed in a stainless steel flask with Ultra-Turrax T50, produced by IKA Works, Inc.

0.1 part of polyaluminum chloride is added thereto, and the dispersion operation is continued with Ultra-Turrax at a rotation number of 6,000 rpm for 10 minutes. The flask is heated to 48° C. over a heating oil bath under slowly stirring and maintained at 48° C. for 60 minutes, to which 20 parts of the resin particle dispersion liquid (1) is gradually added.

Thereafter, after adjusting the system to pH 8.5 with a 0.5 mol/L sodium hydroxide aqueous solution, the stainless steel flask is sealed, and the content thereof is heated to 55° C. under continuous stirring using a magnetic seal, followed by maintaining for 10 hours.

After completing the reaction, the content of the flask is cooled, filtered and sufficiently washed with ion exchanged water, and then subjected to solid-liquid separation by suction filtration with a Buchner funnel. The solid content is again dispersed in 1 L of ion exchanged water at 40° C. and washed by stirring at 300 rpm for 15 minutes.

The washing operation is repeated in five times, and at the time when pH of the filtrate reaches 7.5 and the electric conductivity reaches 7.0 μS/cmt, the solid content is subjected to solid-liquid separation by suction filtration with a Buchner funnel using No. 5A filter paper. Subsequently, the solid content is subjected to vacuum freeze drying for 12 hours to obtain toner particles having a structure containing three kinds of photosensitive and heat-sensitive capsules dispersed therein.

The measurement of the particle diameter of the toner particles with a Coulter Counter reveals that the volume average particle diameter D50v is about 15 μm.

100 parts of the toner (1) is mixed with 0.3 part of hydrophobic titania having an average particle diameter of 15 nm and having been subjected to a surface treatment with n-decyltrimethoxysilane and 0.4 part of hydrophobic silica (NY50, produced by Nippon Aerosil Co., Ltd.) having an average particle diameter of 30 nm by using a Henschel mixer at a circumferential velocity of 32 m/s for 10 minutes, followed by removing coarse particles by using a sieve having an opening of 45 μm, to obtain an externally added toner 3 having an external additive added thereto.

### Production of Toner Supply

A ferrite carrier having an average particle diameter of 50 μm is prepared by coating a surface of a carrier core material with polymethyl methacrylate (Soken Chemical & Engineering Co., Ltd.) at an amount of polymethyl methacrylate of 1% by mass based on the total amount of the carrier. The carrier is stirred and mixed with the externally added toners 1 to 3 having been weighed to make a toner concentration of 5% by mass for 5 minutes with a ball mill to prepare toner supplies 1 to 3.

### Example 1

### Image Formation

An image forming apparatus shown in FIG. 1 is prepared, and the toner supply 1 (negatively charged toner) is used as a toner supply.

An aluminum simple tube having a diameter of 30 mm is mirror finished to a reflectivity of 95% to prepare an aluminum drum (conductive medium), which is used as the image carrying member 10.

The toner recovering and feeding device 12 is a two-component magnetic brush developing device equipped with a metallic sleeve for two-component magnetic brush development, which is configured to form a uniform toner layer on the surface of the image carrying member 10 through solid development. The toner charging amount when the toner supply is installed in the toner recovering and feeding device 12 is about from −5 to −30 μC/g.

The toner image forming device 14 is an ion stream control head having a corona charging device (ion generating source) having formed on the whole surface thereof control slits (control electrodes with slits) at a resolution of 600 dpi.

The color forming information applying device 16 is an LED image bar having a resolution of 600 dpi capable of emitting light having a peak wavelength of 405 nm (exposure amount: 0.2 mJ/m²), 532 nm (exposure amount: 0.2 mJ/m²) and 657 nm (exposure amount: 0.4 mJ/m²).

The transferring device 18 is a corotron fabricated with an aluminum chassis and a gold-plated tungsten wire having a diameter of 60 μm as a corona wire.

The fixing device 20 is a fixing device used in DPC 1616, produced by Fuji Xerox Co., Ltd., and disposed at a position apart from the site for applying color forming information by 30 cm.

The light radiating device 22 is a high brightness Schaukasten containing the three wavelengths of the color forming information applying device with an irradiation width of 5 mm.

The image forming apparatus is configured to have the following printing conditions.

Linear velocity of image carrying member: 10 mm/sec

Negatively charged toner feeding condition: The toner is fed to a metallic roll at a toner supply amount of 400 g/m² to provide a toner developed amount on the image carrying member of 5 g/m² in terms of solid image, in which the peripheral velocity ratio of the metallic roll to the image carrying member (metallic roll/image carrying member) is 2.0, the feeding gap is 0.5 mm, and rectangular waves of a direct current of −330 V accumulated with an alternating current Vpp of 1.2 kV (3 kHz) are applied to the metallic sleeve.

Positively charged toner image forming condition: The control slits are controlled corresponding to an image of a logical sum of image formation information of four colors, Y, M, C and K, and a voltage of 8 kV is applied to the ion generating source (corona charging device) to apply positive ions, whereby a positively charged toner image is formed. The charge amount of the positively charged toner after applying positive ions is from +5 to +30 μC/g.

Transferring bias: direct current of −8 kV applied

Fixing temperature: 180° C. as the surface temperature of the fixing roll

Illuminance of light radiation device: 130,000 lux

A chart having gradation image parts for Y, M, C, R, G, B and K colors, respectively, is printed under the aforementioned conditions. The application of color forming information to the toner is carried out with the combinations shown in Table 1 below, which shows that the toner is colored to desired colors when the LED attached with a mark “x” emits light. In order to control the coloration density by illumination intensity or illumination time, time width modulation where the time within one dot is divided into 8 channels is employed.

TABLE 1

| | | Coloration color | | | | | | | |
|---|---|---|---|---|---|---|---|---|---|
| | | Y | M | C | R | G | B | K | W |
| LED | 405 nm | | x | x | | | x | | x |
| wavelength | 532 nm | x | | x | | x | | | x |
| | 657 nm | x | x | | x | | | | x |

### Evaluation of Image

The printed sample obtained under the aforementioned conditions is evaluated as follows.

### Coloration Density

The solid images of Y, M and C colors are measured for image density with a densitometer X-Rite 938 (produced by X-Rite, Inc.), and the image density is 1.5 or more for all the colors to provide sufficient coloration.

### Color Reproducibility

The color reproducibility is evaluated for R, G, B, Y, M and C colors with gradation charts of from 5% to 100% with a step of 5%, and excellent color reproducibility with good color balance is obtained in all the colors.

### Reproducibility of Highlight Image

The reproducibility of a highlight image is evaluated with a halftone image of 15% of printed surface, and a favorable printed image with no white out in the highlight part is obtained.

### Example 2

Image formation is carried out in the same manner as in the image formation in Example 1 except that the linear velocity of the image carrying member 10 is changed to 300 mm/sec, and the resulting image is evaluated in the same manner as in Example 1. A non-fixed image is output under the same conditions with the fixing device and the light radiating device detached, and after allowing the non-fixed image to stand for 10 minutes in a dark place, the image is then fixed and irradiated with light under the same conditions to obtain an image.

As a result, images equivalent to that obtained in Example 1 in terms of coloration density, color reproducibility and reproducibility of highlight image are obtained, irrespective to whether or not the non-fixed image is allowed to stand.

### Example 3

Image formation is carried out in the same manner as in the image formation in Example 1 except that the toner supply 2 is used instead of the toner supply 1.

As a result, a coloration density equivalent to Example 1 is obtained at least in the initial image, and better results than Example 1 are obtained in color reproducibility and reproducibility of highlight image by visual evaluation.

### Example 4

Image formation is carried out in the same manner as in the image formation in Example 1 except that the toner supply 3 is used instead of the toner supply 1, and the application of color forming information to the toner is changed to the combinations shown in Table 2 below.

As a result, the coloration density is 1.5 or more, and results equivalent to Example 1 are obtained in color reproducibility and reproducibility of highlight image by visual evaluation. Accordingly, in the case where a light coloring type toner is used, excellent characteristics are obtained in coloration density, color reproducibility and reproducibility of highlight image, as similar to the case where a light non-coloring type toner is used in Example 1.

TABLE 2

| | | Coloration color | | | | | | | |
|---|---|---|---|---|---|---|---|---|---|
| | | Y | M | C | R | G | B | K | W |
| LED | 405 nm | x | | | x | x | | x | |
| wavelength | 532 nm | | x | | x | | x | x | |
| | 657 nm | | | x | | x | x | x | |

### Comparative Example 1

### Production of Toner

A microcapsule-containing sheet disclosed in Japanese Patent No. 2,979,158 is produced. Specifically, polyurethane is used as a wall material of the microcapsules, and a phospholipid bimolecular membrane associated with azobenzene as a photoisomerizing substance is buried in the fine pores of the wall material. A leuco dye is included inside the microcapsules, which are dispersed in methyl cellulose containing α-naphthol as a developer to prepare a sheet.

The sheet is finely cut and pulverized with a jet mill to prepare particles having an average particle diameter of about 20 μm. The same external additive is added to the particles in the same manner as above, and a carrier is mixed therewith to obtain a toner supply 4.

All the aforementioned operations are carried out in a dark place.

### Evaluation

Image formation is carried out in the same manner as in the image formation in Example 4 except that the toner supply 4 is used instead of the toner supply 3. Furthermore, image formation is carried out in the same manner as above except that the linear velocity of the image carrying member 10 is changed to 300 mm/sec, and is further carried out except that the non-fixed image is allowed to stand for 10 minutes in a dark place, followed by subjecting to fixing and irradiation with light.

As a result, when the linear velocity of the image carrying member is 10 mm/sec, the resulting image has a low density (image density: about 0.8 on average) and suffers considerable white out in highlight part. When the linear velocity of the image carrying member is 300 mm/sec, the image density and the color tone are restored (image density: about 1.0 on average), but white out is observed in highlight part with considerable white out occurring in a halftone image of 20%. A printed sample where the non-fixed image is allowed to stand for 10 minutes in a dark place exhibits substantially no coloration, and no image can be distinguished.

As having been described hereinabove, according to the image forming apparatus and the image forming method using the toner of the invention in Examples, images can be stably obtained without fluctuation even when the linear velocity of the image carrying member is largely changed, and an image with high quality can be obtained with good reproducibility of a highlight image part. In the case where the toner of Comparative Example different in coloring mechanism is used, on the other hand, a stable image cannot be obtained with the same constitution of the apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. An image forming apparatus comprising:
an image carrying member,
a toner feeding unit that forms a charged toner on a surface of the image carrying member,
a toner image forming unit that forms a reversely charged toner image by applying charge to the charged toner according to image information, the applied charge having a polarity contrary to the charged toner formed on the surface of the image carrying member,
a color forming information applying unit that applies color forming information to the reversely charged toner image with light,
a transferring unit that transfers the reversely charged toner image to a surface of a recording medium,
a fixing unit that fixes the reversely charged toner image transferred to the surface of the recording medium, and
a color forming unit that forms color of the toner image applied with the color forming information,
the charged toner comprising a first component and a second component that are capable of being colored upon reaction with each other, and are separated from each other in the toner, and a photo-curable composition containing at least one of the first component and the second component,
the reaction for forming the color being controlled by maintaining a cured state or an uncured state of the photo-curable composition by application of color forming information with light.

2. The image forming apparatus as claimed in claim 1, wherein the image carrying member is a conductive medium, and the toner image forming unit that forms the reversely charged toner image is an ion writing unit.

3. The image forming apparatus as claimed in claim 1, wherein the toner feeding unit also recovers a remaining toner remaining on the image carrying member after transferring.

4. The image forming apparatus as claimed in claim 1, wherein the apparatus further comprises a toner recharging unit that applies charge having the same polarity as the charged toner to the remaining toner.

5. The image forming apparatus as claimed in claim 1, wherein the fixing unit also functions as the color forming unit.

6. The image forming apparatus as claimed in claim 1, wherein the apparatus further comprises a light radiating unit that radiates light to the recording medium after fixing.

7. The image forming apparatus as claimed in claim 1, wherein the charged toner contains a microcapsule dispersed in the photo-curable composition, the first component is contained in the microcapsule, and the second component is contained in the photo-curable composition.

8. The image forming apparatus as claimed in claim 7, wherein the photo-curable composition contains the second component and a polymerizable compound.

9. The image forming apparatus as claimed in claim 7, wherein the second component has a photopolymerizable group.

10. A method for forming an image comprising:
forming a charged toner on a surface of an image carrying member;
forming a reversely charged toner image by applying charge to the charged toner according to image information, the applied charge having a polarity contrary to the charged toner;
applying color forming information to the reversely charged toner image with light;
transferring the reversely charged toner image to a surface of a recording medium;
fixing the reversely charged toner image transferred to the surface of the recording medium; and
forming color of the toner image applied with the color forming information,
the charged toner comprising a first component and a second component that are capable of being colored upon reaction with each other, and are separated from each other in the toner, and a photo-curable composition containing at least one of the first component and the second component,
the reaction for forming the color being controlled by maintaining a cured state or an uncured state of the photo-curable composition by application of color forming information with light.

11. A toner comprising a coloring agent, and a photo-curable developer monomer capable of being colored upon reaction with the coloring agent.

12. The toner as claimed in claim 11, wherein
the coloring agent and the photo-curable developer monomer are separated from each other in the toner, and
a polymer formed through photopolymerization of the photo-curable developer monomer is contained in the toner to prevent from being reacted with the coloring agent.

13. The toner as claimed in claim 11, wherein
at least one of the coloring agent and the photo-curable developer monomer are contained in a microcapsule, and
a polymer formed through photopolymerization of the photo-curable developer monomer dose not pass a wall of the microcapsule.

14. The toner as claimed in claim 11, wherein
the coloring agent is selected from an electron donative colorless dye and a diazonium salt compound, and
the photo-curable developer monomer is selected from an electron acceptive compound and a coupler compound having a photopolymerizable group.

15. The toner as claimed in claim 14, wherein
the coloring agent is an electron donative colorless dye, and
a content of the electron donative colorless dye at a coloring part in the toner is from about 0.01 to about 3 g/m².

16. The toner as claimed in claim 14, wherein
the coloring agent is an electron donative colorless dye, and the photo-curable developer monomer is a coupler compound having a photopolymerizable group, and
the coupler compound is contained in an amount of from about 0.5 to about 20 parts by mass per 1 part by mass of the electron donative colorless dye.

17. The toner as claimed in claim 14, wherein
the coloring agent is a diazonium salt compound, and
a content of the diazonium salt compound at a coloring part in the toner is from about 0.01 to about 3 g/m².

18. The toner as claimed in claim 14, wherein
the coloring agent is a diazonium salt compound, and the photo-curable developer monomer is a coupler compound having a photopolymerizable group, and
the coupler compound is contained in an amount of from about 0.5 to about 20 parts by mass per 1 part by mass of the diazonium salt compound.

19. The toner as claimed in claim 11, wherein
the toner further comprises a spectral sensitizing dye and a borate compound, and a ratio of the spectral sensitizing dye to the borate compound in the toner is in a range of from about 1/1 to about 1/50.

20. The toner as claimed in claim 11, wherein
the toner has GSDv of about 1.30 or less, GSDv/GSDp of about 0.97 or more, and SF1 of from about 110 to about 130.

21. A toner comprising a coloring agent, a developer capable of being colored upon reaction with the coloring agent, and a photo-polymerizable monomer.

22. The toner as claimed in claim 21, wherein
the coloring agent and the developer are separated from each other in the toner, and
the photo-polymerizable monomer undergoes photopolymerization to form a polymer, whereby the coloring agent and the developer are reacted to each other to form the color.

23. The toner as claimed in claim 21, wherein
at least one of the coloring agent and the developer are contained in the microcapsule.

24. The toner as claimed in claim 22, wherein
the photo-polymerizable monomer contains decoloration reaction group capable of inhibiting color forming reaction between the coloring agent and the developer.

25. The toner as claimed in claim 21, wherein
the coloring agent is a polymerizable compound having an ethylenic unsaturated bond, and
the developer is selected from a phenol derivative, an organic carboxylic acid derivative and a metallic salt thereof, a sulfonic acid derivative, urea and thiourea derivatives, acid clay, bentonite, a novolac resin and a metallic complex.

26. The toner as claimed in claim 21, wherein
the toner further comprises a thermal polymerization inhibitor.

27. The toner as claimed in claim 21, wherein
the toner has GSDv of about 1.30 or less, GSDv/GSDp of about 0.97 or more, and SF1 of from about 110 to about 130.
